(19) United States
(12) Patent Application Publication
(10) Pub. No.: US 2018/0283561 A1
(43) Pub. Date: Oct. 4, 2018

(54) Twin seal rotary valves and hybrid high integrity pressure protection systems

(71) Applicant: Jianchao Shu, cypress, TX (US)

(72) Inventor: Jianchao Shu, cypress, TX (US)

(21) Appl. No.: 15/928,196

(22) Filed: Mar. 22, 2018

Related U.S. Application Data
(60) Provisional application No. 62/479,252, filed on Mar. 30, 2017.

(51) Int. Cl. F16K 5/06; F16K 5/08; F16K 31/14

(52) U.S. Cl. CPC F16K 5/06; F16K 5/0663; F16K 31/60; F16K 31/14; F16K 5/08

(57) ABSTRACT

This invention relates to twin seal rotary valves and Hybrid High Integrity Pressure Protection System (H-HIPPS) for critical services, the hybrid system includes a quick isolation subsystem between an overpressure zone and a normal pressure zone and a quick releasing subsystem between the overpressure zone and a lower pressure zone with quadruple redundancies for long service without repair, more particularly, the hybrid system has the novel rotary valve with at least two offsets, twin closure members, twin wedge seal seat assemblies, the valve operation mechanism is a combination of rotary movements and linear movement between close and open positions for blocking and releasing over pressurize fluids and protecting and the valves and the pipelines or the process plants from surge pressure, fire or leak at the highest level of a system reliability.

### CROSS-REFERENCE TO RELATED APPLICATION

This application claims the benefit of provisional patent application Ser. No. 62/479,252 filed on Mar. 30, 2017 by the present inventor.
Federally sponsored research No
Sequence listing or program No

### BACKGROUND

This invention relates to twin seal rotary valves and Hybrid High Integrity Pressure Protection System (H-HIPPS) for critical services, the hybrid system includes a quick isolation subsystem between an overpressure zone and a normal pressure zone and a quick releasing subsystem between the overpressure zone and a lower pressure zone with quadruple redundancies, more particularly, the hybrid system has the novel rotary valve with at least two offsets, twin closure members, twin wedge seal seat assemblies and an novel operation mechanism, a combination of rotary movements and linear movement between closed and open positions for isolating and releasing over pressurize fluids and protecting the valves, actuators and the pipelines or the process plants from surge pressure, fire or leak at the highest level of a system reliability, the quick isolation subsystem has redundant closure members, redundant seats, redundant power supplies, redundant driving system with less than one second closure time while the quick releasing subsystem has the novel hybrid and redundant, rotary pressure relief mechanisms, redundant pressure sensing mechanisms and trims to suppress cavitation and erosion with near zero blowdown pressure and greatly reduce energy loss while still protecting the normal pressure zone from over pressurized fluids.

When pipelines, compression or pumping stations or process plants, pressure vessel are in services, very often, the operations like open and closing, heating or pumping and metering can cause water hammer and pressure surge or fire, leaks, the pressure surge fire or leaks in pipelines or plant can cause many problems as following; (a) Axial temporal and permanent separation of flange joints (b) Pipe fatigue at weld joints (c) Longitudinal pipe splits (d) Severe damage to piping and piping supports (e) loss of property or life (f) Pipe leak (g) High cost for constant repair (h) inaccurate metering due to leaks in supply stations (i) environmental pollution.

There are two current solutions for the problem (1) to block the overpressure fluid or fire zone into a normal pressure zone or (2) to release the overpressure fluid or fired fluid into a low pressure zone or safety tank.

With HIPPS, the overpressure protection is achieved by reducing to a tolerable degree the risk that the pressure can exceed certain maximum levels. HIPPS design is governed by:
IEC 61508: “Functional Safety of Electrical/Electronic/Programmable Electronic Safety Related Systems”
IEC 61511: “Functional Safety: Safety Instrumented Systems for the Process Sector,”
ANSI/ISA S84.01-1996, “Application of Safety Instrumented Systems (SIS) for the Process Industry,”
   API 17O Recommended Practice for Subsea High Pressure Protection Systems (HIPPS)

In most cases, the HIPPS is equipped with two shut off valves, two actuators and pressure transmitters and a feedback control system, but this subsystem at this point is just a combination of conventional parts like two ball valves, two actuators and pressure sensors and controller and is constructed under overpressure class at least two or three time in overpressure fluid zone even for a short period time and waste lot of materials and capacity in normal pressure conditions, here is the current problems;
1. According to API 6D 24 edition, no current ball valves either in float or trunnion style are classified as double isolating and bleeding (DIB) valve. The DIB valve can provide positive seals in one or two sides under pressures, the conventional ball valves cannot provide positive seals in one or two side under pressure are classed as a double block and bleeding (DIB) valve so two ball valves must be used in the HIPPS.
2. High operation toque due to constant high contact friction between ball and seat in either float or trunnion styles.
3. High operation toque due to fast acceleration during closing time, according to Newtown second law, with a given heavy mass of the closure members, the higher acceleration, the more toque, in most cases, the closing time is more than 4 seconds.
4. Lack of redundancy of power supply, the pipeline valves are sometime powered by the gas fluid through the pipeline, such as a gas over oil actuator, once pipeline is shut down there is no other power supply to operate the valves.
5. Lack of diversification of power supply, in the most system there is no override feature for manual or secondary actuation system, which is very important feature for the most systems in subsea pipeline protection or remote pumping or compression stations.
6. High shaft fugitive emission for both static and dynamic seal under API 622, 624, 641, due to high speed close or high cycle operation, the conventional shaft packing like V packing graphite yard packing lip seal do not distinguish dynamic seals from static seals and cannot stand the stem side load impact and torsional movement and high cycles.
7. Lack of reliability test, partial stroke test is only a game in town, but it is still partial stroke not full stroke, the most important position is the close position after all, while partial stroke test can cause an accident activation and shut down the plant or pipelines.
8. High cost due to two overpressure rated ball valves, two oversized actuators,
9. Less efficiency, since the oversized HIPPS is only used for blocking oversized pressure zone and protecting the system for a short period.
10. High repair cost due to fast closed impact on seat and stem packing seal or high cycle operation.
11. Lack of system redundancy, current HIPPS has only one pressure block system with only one power supply, with high risk in case of unexpected high pressure or one power system is shut down.
12. Lack of override function

So far there is no single valve or actuator, which are developed for the high integrity system.

The conventional quick releasing subsystem is constructed as an overpressure safety device under U.S. Department of Transportation, Pipeline Safety Regulations, Hazardous Liquids Part 195, paragraph 195.428, the subsystem includes the pressure surge relief valve like plug axial pressure surge relief valves, those valves are widely used in the pipeline protection from pressure surge and constructed with main three functions; sensing, tracking and releasing, the plug axial pressure surge relief valves have two types, a gas loaded and a pilot operated configurations, the gas loaded pressure surge relief system has a fast response time about 250 millisecond, but it is equipped with external energy resources like pressurized bottle nitrogen pressure regulator, check valve, tubing, insulated plenum bottle and control boxes, there are the following problems;
1. Failure to sensing or keeping a set dynamic pressure after the release valve closure member opens, the conventional mechanism for all release valves are based on compression spring or compression gas, the more open the closure member,the more compression force or the more compression pressure of the gas, in turn the more set dynamic pressure, it is an inherent problem for all pressure relief valves in that nature.
2. Lack of redundancy, in most applications, the conventional pressure relief system only is equipped with one pressure relief valve, in case point in 1999, a pressure relief valve failed on a 16-inch gasoline pipeline operated by the Olympic Pipe Line Company in Bellingham, Wash., spilling 277,000 gallons of gasoline into the river. The gasoline exploded, killing three young boys. The incident resulted in five felony convictions for Olympic employees and a $75 million wrongful death settlement. Because of failure of single pressure surge relief valve.
3. High blowdown pressure and slow recovery for the most pressure relief system, the blowdown pressure is designed with above 25% of normal pressure with a set static pressure, but even the pressure relief systems reach the set static pressure, the system continue to increase a set dynamic pressure over set static s pressure due to the valve opening proportional to the spring compression or gas compressibility, in fact, the blowdown pressure can reach about 30 to 40% above, the high blowdown system not only greatly waste the energy, but also delay the system recovery to normal operation pressure.
4. Slow releasing time the full releasing time is between release valve opening and pressure reaching normal pressure, even for the gas loaded pressure relief would take seconds to fully release overpressure fluid, for now the response time is used to describe the release system by most manufactures, but it is useless even with the 200 millisecond, only full release time can take 2 or seconds to finish, the full releasing time is a single factor to determine if or how much damage can cause.
5. High cavitation and erosion damage in the system, as more and more pipeline system or process plants adapted lower overpressure standard 3% to 10% over normal pressure, the less the margin gets smaller between normal pressure and overpressure, the more often the system releases overpressure during the operations as a result, high cycles between open and close operations cause high cavitation and erosion damages, the dilemma is in order to ease the cavitation and erosion, the more flow restrictions are need, while the more restrictions, the slower the releasing operation.
6. High cost on the gas loaded pressure relief system, the system is equipped with a skid pressurized gas bottles and pressure regular control box, tank.
7. Lower reliable pilot operated pressure relief system, for most the crude oil only gas load system is sued because of crude oil can block the pilot valve passage even with filter, and the respond time for the pilot system is about two seconds or more.
8. Lack of override function, the conventional pressure relief systems have no override function, so the system cannot be tested or inspected after installation or during in services.
9. Lack of durability, the conventional pressure relief systems are subject to regular six month replacement of seal goods, the maintenance bring high costs specially in remote areas.
10. Lack of fire safety, the conventional pressure relief systems are not fire safety, in term of materials or test procedure under API 6FA.

The releasing subsystem not only reduce a system reliability, but also has high operation cost to remain the set pressure with high cavitation and erosion damages while the pilot relief system is operated by internal fluid energy with a compact pilot, but the pilot has a remote pressure sensing function and slow response time about two second or more and is less tolerated with dirty fluid and unreliable, every pressure releasing can cause 10 to 30% pressure or energy loss.

In short the both type subsystems do not work efficiently and reliably as a separated or combined unit and have no redundancy and cannot provide a good seal at low temperature, or high temperature or under high speed operations and come with high blow down pressure up to 30% and waste significant fluid energy and need constant seal goods replacements.

So the flow control industry has long sought means of improving the performance of the pressure protection valve and the systems, improving the seal, creating a robust hybrid system, enabling the valve to handle various flows under multiple extreme conditions.

In conclusion, insofar as I am aware, no such a system is formerly developed with versatile seal ring assembly, hybrid highly reliable pressure protection system, easy manufacturing at lower cost, they can be used for blocking and releasing overpressure fluids in critical services.

### SUMMARY

This invention provides a simple, robust, reliable and versatile hybrid pressure protection system for critical services or under extreme conditions. This hybrid pressure protection system not only release overpressure fluid into lower pressure zone but also isolate overpressure fluid from normal pressures zone, and greatly reduce total isolation time, increase reliability with four redundancies, the subsystem has a valve integrated with actuators, the valve has twin seal seats, two closure members in one valve body, with a novel operation: rotary and linear movements between close and open positions, it reduce the isolating time less than 2 second without damaging seat and shaft seal packing, the system with redundancy feature for the valves and the actuators include two closures members, two pressure sensing devices, two pressure relief paths, two pressure protection methods and it has the highest level of system reliability over all prior arts or existing products.

Accordingly, besides objects and advantages of the present invention described in the above patent, several objects and advantages of the present invention are:
(a) To provide high redundant pressure protection system, such a system has the highest system reliability for critical services or extreme conditions.
(b) To provide a pressure sensing device with a fast response time and releasing time, even after opening valve, so such a system can keep the set dynamic pressure closed to the set static pressure and protect a pipeline or pressure vessel for critical service and has long life with high reliability.
(c) To provide seal with ability to sustain high closing impact force for extreme conditions: fast closing, high pressure, cryogenic or high temperature or fire-safe applications. Such a seal ring can keep good static and dynamic seals with low leakage between 0-50 ppm.
(d) To provide a device with functions to reduce erosion and cavitation as well as to monitor, detect and predict the process of erosion and cavitation, so the system has an ability to prevent fluid leak and predict efficiently the repair damage or replacements at designed timing before the accidents happen.
(g) To provide a highly efficient movable trim in a choked flow, so such a trim has a compact, simple structure to reduce the cavitation and erosion and absorb high jet fluid impact.
(j) To provide a highly efficient trim to reduce the cavitations without reducing the flow capacity. so such a trim can handle slurry fluid or fluid with solid particles or dissipate fluid energy under high pressure like damping valve used in water dam.
(l) To provide a pressure protection system with solid/liquid interaction mechanisms to reduce the isolating time and releasing time, so the system can reduce the damage of pressure surge to minimum level.
(m) To provide pressure protection system, so the system last 25 year service and fire safety service, the maintain period would increase at least five year period and reduce the operation cost and increase reliability.
(n) To provide stronger, fast and reliable actuators system, so the valve can actuated fast to closed or open for blocking and release over pressurized flow and with safety protection from unauthorized operation.
(o) To provide versatile actuators connection, so the valve can actuated with hydraulic, pneumatic,solar and electrical power supply or manual or diver interface under subsea operation, such connection not only reduce the air pollution but also increase reliability, more importantly the full stroke test can be taken for the actuators while the valves are still in operation conditions, so the whole H-HIPPS would become really “high integrity” system.

Still further objects and advantages will become apparent from study of the following description and the accompanying drawings.

### DRAWINGS

Drawing Figures

FIG. 1 is an exploded, quarter cut view of a pressure protection subsystem constructed in accordance with this invention.

FIG. 2 is a front view of block valve of FIG.1 at a close position

FIG. 3 is an exploded view of bonnet assemblies and ball assembly of FIG. 2.

FIG. 4 is a cross sectional view of valve of FIG. 2 along line A-A.

FIG. 5 is a “F” detail views of valve of FIG. 4.

FIG. 6 is a cross sectional view of valve of FIG. 2 along line E-E.

FIG. 7 is a cross sectional view of valve of FIG. 2 along line B-B.

FIG. 8 is a “K” detail view of in the valve of FIG. 4.

FIG. 9 is a front view of closure member assembly of the valve of FIG. 4.

FIG. 10 is a cross sectional view of valve of FIG. 9 along line B-B.

FIG. 11 is a “D” detail view of in the valve of FIG. 10.

FIG. 12 is a bottom view of closure member assembly of the valve of FIG. 9.

FIG. 13 is a front view of the block valve of FIG. 1 at 90 degree position.

FIG. 14 is a cross sectional view of the block valve of FIG. 13 along line A-A.

FIG. 15 is a cross sectional view of the block valve of FIG. 13 along line G-G.

FIG. 16 is a cross sectional view of the block valve of FIG. 13 along line C-C.

FIG. 17 is a front view of the block valve of FIG. 1 at open positions.

FIG. 18 is a cross sectional view of the block valve of FIG. 17 along line B-B.

FIG. 19 is a cross sectional view of the block valve of FIG. 17 along line H-H.

FIG. 20 is a cross sectional view of the block valve of FIG. 17 along line E-E.

FIG. 21 is a front view of the block valve of FIG. 1

FIG. 22 is a cross sectional view of the block valve of FIG. 21 along line F-F.

FIG. 23 is a cross sectional view of the block valve of FIG. 17 along line G-G.

FIG. 24 is a “H” detail view of block valve of FIG. 19.

FIG. 25 is a front view of the relief valve of FIG. 1.

FIG. 26 is a cross sectional view of valve of FIG. 25 along line B-B.

FIG. 27 is a cross sectional view of valve of FIG. 25 along line D-D.

FIG. 28 is a front view of a closure member assembly of valve of FIG. 25.

FIG. 29 is a cross sectional view of the assembly of FIG. 28 along line A-A.

FIG. 30 is a cross sectional view of the assembly of FIG. 28 along line F-F.

FIG. 31 is a “G” detail view of valve of FIG. 30.

FIG. 32 is a front view of relief system with actuator of FIG. 1.

FIG. 33 is a cross sectional view of relief system of FIG. 30 along line P-P.

FIG. 34 is a cross sectional view of the actuator of FIG. 31 along line A-A.

FIG. 35 is a “Y” detail view of valve of FIG. 33.

FIG. 36 is a side view of actuator adaptor of FIG.32.

FIG. 37 is a cross sectional view of valve of FIG. 36 along line R-R.

FIG. 38 is a cross sectional view of valve of FIG. 36 along line T-T.

FIG. 39 is a front view of twin block system of FIG. 1.

FIG. 40 is a cross sectional view of valve of FIG. 39 along line C-C.

FIG. 41 is a front view of a coupling assembly of FIG. 40.

FIG. 42 is a “Y” detail view of valve of FIG. 41.

FIG. 43 is a cross sectional view of valve of FIG. 42 along line D-D.

FIG. 44 is a cross sectional view of valve of FIG. 42 along line A-A.

FIG. 45 is a “B” detail view of valve of FIG. 40.

FIG. 46 is a “Z” detail view of valve of FIG. 40.

FIG. 47 is a ISO view of actuator adaptor of FIG. 1.

FIG. 48 is a front view of actuator adaptor of FIG. 1.

FIG. 49 is a cross sectional view of the adaptor of FIG. 48 along line B-B.

FIG. 50 is a cross sectional view of the adaptor of FIG. 48 along line A-A.

FIG. 51 is a cross sectional view of the adaptor of FIG. 48 along line D-D.

FIG. 52 is a cross sectional view of the adaptor of FIG. 48 along line G-G.

FIG. 53 is a “F” detail view of the actuator adaptor of FIG. 49.

FIG. 54 is a “E” detail view of the actuator adaptor of FIG. 49.

FIG. 55 is an exploded, quarter cut view of an actuator of FIG. 1

FIG. 56 is a “C” detail view of the actuator of FIG. 55

FIG. 57 is a “D” detail view of the actuator of FIG. 55

FIG. 58 is a “A” detail view of the actuator of FIG. 55

FIG. 59 is a “H” detail view of the actuator of FIG. 55

FIG. 60 is a “J” detail view of the actuator of FIG. 55

FIG. 61 is a front view of the actuator of FIG. 55.

FIG. 62 is a cross sectional view of the actuator of FIG. 61 along line B-B.

FIG. 63 is a cross sectional view of the actuator of FIG. 61 along line K-K.

FIG. 64 is a front view of a partial right helical driving assembly, partial base driving assembly and partial left helical driving assembly of FIG. 61.

FIG. 65 is an exploded view of partial base driving assembly

FIG. 66 is a front view of a position bushing of FIG. 65

FIG. 67 is a “L” detail view of a position bushing of FIG. 66

FIG. 68 is a cross sectional view of the actuator of FIG. 66 along line G-G.

FIG. 69 is a cross sectional view of the actuator of FIG. 62 along line D-D.

FIG. 70 is a front view of an alternative base actuator of FIG. 55.

FIG. 71 is a cross sectional view of the actuator of FIG. 70 along line L-L.

FIG. 72 is a cross sectional view of the actuator of FIG. 70 along line N-N.

FIG. 73 is a cross sectional view of the actuator of FIG. 70 along line B-B.

FIG. 74 is a front view of partial driving assembly of FIG. 70.

FIG. 75 is a top view of partial driving assembly of FIG. 74.

FIG. 76 is a bottom view of partial driving assembly of FIG. 74.

FIG. 77 is a cross sectional view of the actuator of FIG. 70 along line P-P.

FIG. 78 is a front view of an alternative helical actuator of FIG. 55.

FIG. 79 is a cross sectional view of the actuator of FIG. 78 along line C-C.

FIG. 80 is a “G” detail view of the actuator of FIG. 79.

FIG. 81 is a “M” detail view of the actuator of FIG. 79.

FIG. 82 is a “K” detail view of the actuator of FIG. 79.

FIG. 83 is a “H” detail view of the actuator of FIG. 79.

FIG. 84 is a front view of an alternative helical actuator of FIG. 55.

FIG. 85 is a cross sectional view of the actuator of FIG. 84 along line D-D.

FIG. 86 is a cross sectional view of the actuator of FIG. 84 along line E-E.

FIG. 87 is a front view of an offset sleeve of FIG. 84.

FIG. 88 is a cross sectional view of the offset sleeve of FIG. 87 along line F-F.

FIG. 89 is a ISO view of handle assembly of FIG. 1.

FIG. 90 is a front view of the handle assembly of FIG. 89.

FIG. 91 is a cross sectional view of the handle assembly of FIG. 90 along line C-C.

FIG. 92 is a cross sectional view of the handle assembly of FIG. 90 along line D-D.

### DESCRIPTION

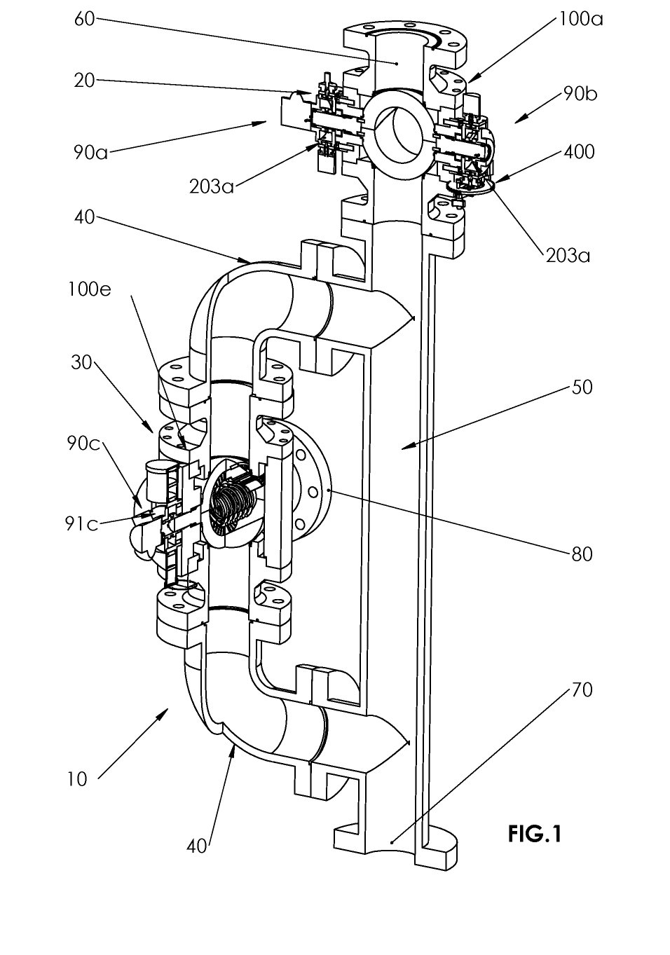

FIGS. 1-92 illustrate a pressure protection system 10 with a twin pressure isolate system 20 with a system outlet 60 and a twin pressure relief system 30 with a release port 80 connected with two elbows 40 and a pipe 50 with a system inlet 70 and is constructed in accordance with the present invention.

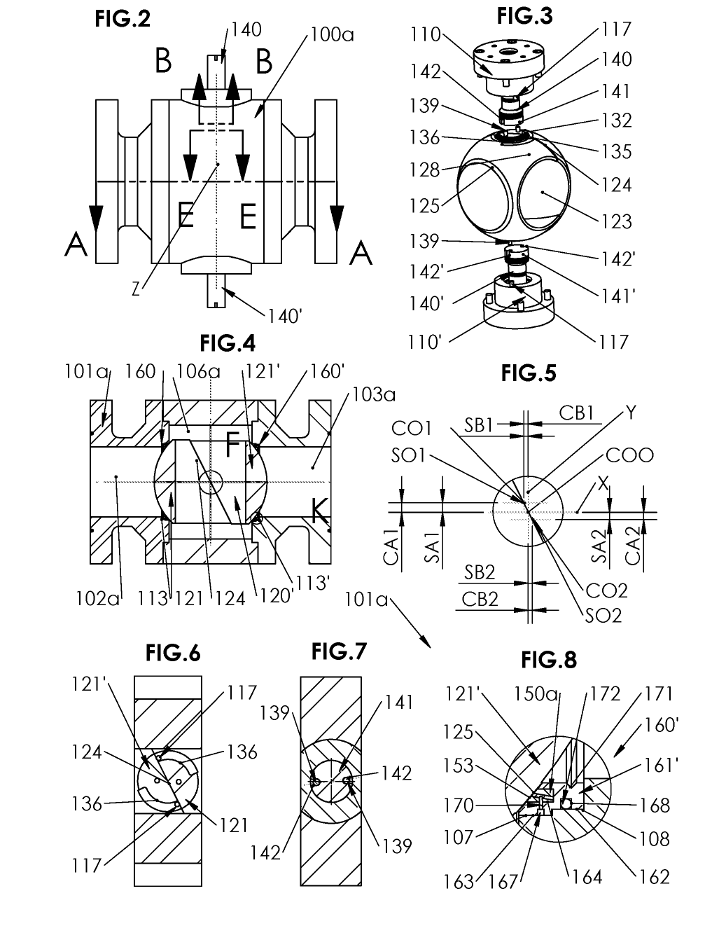

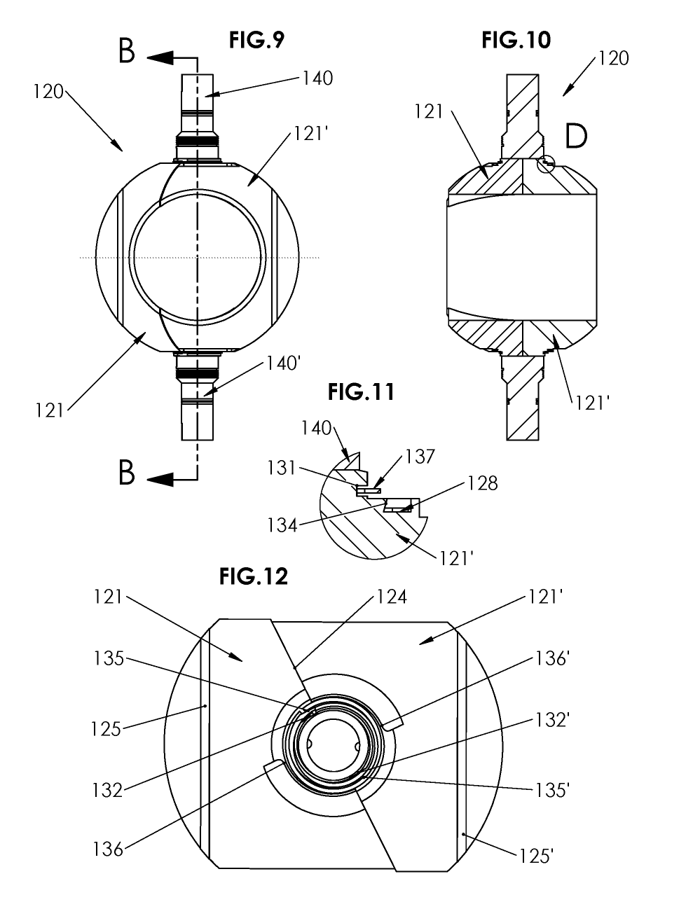

Referring FIGS. 1-12, the pressure isolate system 20 comprises a valve 100a, the valve 100a has a body assembly 101a having a body bore 106a, an inlet port 102aconnected with the pipe 50 and an outlet port 103a and a closure member 120 movably disposed in said bore 106a and is defined by a X axis, a Y axis, a Z axis and a center COO, the body assembly 101a has a left seat assembly 160 with offsets SA1, SB1, an off center SO1 and a right seat assembly 160′ with offsets SA2, SB2, an off center SO2 in an opposition direction, the closure member 120 defined by a X axis, Y axis, Z axis has a left closure 121 with offsets CA1, CB1, an off center CO1 at a closed position, a right closure 121′ with offsets CA2, CB2, an off center CO2 at a closed position as shown in FIG. 4, the left closure 121 and the right closure 121′ are engaged by a wedge parting surface 124, the angle between the parting surface 124 and a X axis is larger than 0 degree and smaller than 90 degree from the X axis, the parting surface 124 is defined by the center COO, offsets centers CO1, SO1, CO2 and SO2. The seat assembly 160′ has a seat body 161′ including an installing groove disposed in a right seat pocket 113′, the seat body 161′ has a back sealing OD surface 162 against a back bore 108 surface of the seat pocket 113′ for sealing between surface 107 and a front OD surface 163 against a front bore surface 107 of the seat pocket 113′ with a press fit for securing the seat assembly 160′, the seat body 161′ is softer than the material of the body 101, so if the seat body 161′ is replaced, the sealing surface 162 and seat pocket seal surface 108 would not be damaged, while even the surface 163 may be damaged but still can be used for press fit, a wedge seal ring assembly 150a disposed in seat body 161′ for sealing between the seat assembly 160 and closure member 121′, there is at least one hole 170 between seat body 161′ and wedge seal ring assembly 150a, the wedge seal ring assembly 150a has an wedge metal ring 155a, an internal nonmetal mated ring 158a and external nonmetal ring 157a and a mated front surface 153a engaged with the sealing band 125 of the closure member 120 for seal, the setscrew 167 is threaded in the hole 170 for securing the seal ring assembly 150a and the spring wedge ring 155a even after fires or at open positions under high vibrations.

The closure member assembly 120 includes the left closure 121, right 121′closure and shafts 140, 141′ and has radial groove 131 and a taped groove 134 on both top and bottom of the left closure 121 and right closure 121′, retaining rings 137 and 138 are respectively inserted into the grooves 131 and 134 for securing the joint between the left closure 121 and the right closure 121, the body assembly 101a has bonnet assemblies 110, 110′, each of the bonnet assemblies 110,110′ has two pair of fixed guide pins 117 to guide the closure member assembly 120 through rotary slots 136, 136′ and move along with the wedge parting surface 124, a linear movement to offset centers CO1, CO2 from the center COO, the closure member assembly 120 has two pair of driver pins 139, shafts 140, 140′, the shafts 140, 140′ have respectively bottom bosses 141, 141′ including drive slots 142,142′ in an opposite direction, the drive slots 142, 142′ of shafts 140,140′ are respectively engaged with two drive pins 139 on the closures 121,121′ for operating between offset centers CO1, CO2 and the center COO.

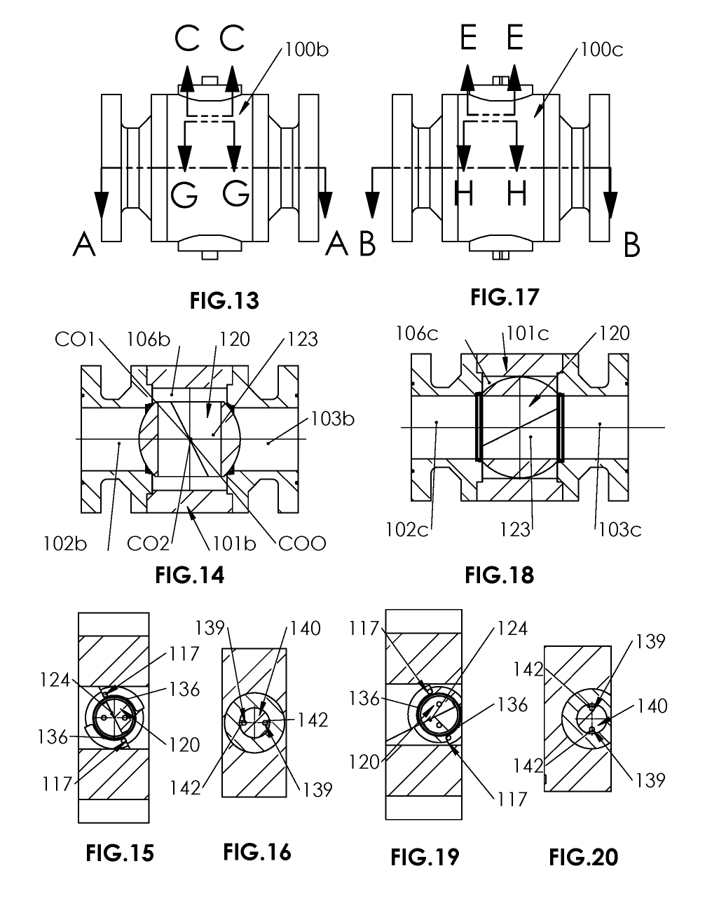

Referring FIGS. 13-16, the closure member assembly 120 moves from offset centers CO1, CO2 to the center of COO by driving two pins 139 in two drive slots 142 along with the wedge parting surface 124, a linear movement of left and right closures 121,121′, rotary slots 136, 136′ guided by pins 117 and move to 90 degree position from the closed position.

Referring FIGS. 17-20, the closure member assembly 120 moves from one end of rotary slots 136,136′ at the center COO to other end of rotary slots 136,136′ at the center COO to open positions through engagement between drive slots 142 and drive pins 139 as a rotary movement.

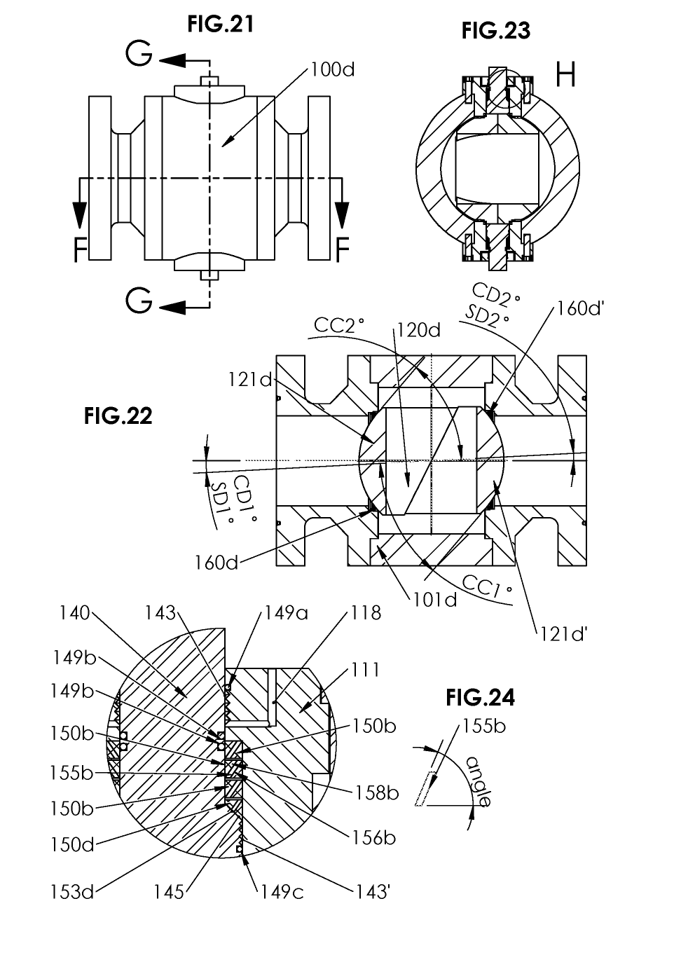

Referring FIGS. 21-24, the isolate valve 100d has a closure member assembly 120d and a seat seal assembly 160d, the closure member assembly 160d has an additional, third offset angles CD1, CD2 from the center line, seat seal assembly 150e has an additional, third offset angles SD1, SD2 on FIG. 22 as two triple offset valves, the isolate valve 100d has four set wedge stem seal assembles 150 and washer support rings around the shaft 140 in the bonnet 111 for seals, the wedge seal assembly 150b has a metal spring wedge ring 155b defined by an angle>0 and <90 degree from X axis, a non-metal internal wedge ring 158b with a mated profile engaged with the spring wedge ring 155b, a non-metal external wedge ring 157b with a mated profile engaged with the spring wedge ring 155b, a wedge seal assembly 150d has a conical front surface 153d against a shoulder 145 of shaft 140 to provide radial and axial seals under compression as well as bearing, since the metal spring wedge ring 155 are made out of a metal material, even after fire without internal ring 157 and external ring 158, the metal spring wedge ring 155 supported by metal washer support rings would be still under compression seals and would have a metal seal between shoulder 145 and the spring wedge ring 155b, the shaft 140 has two seal grooves to receive seal rings 149a, 149b, 149c for dynamic seal, when the shaft 140 rotates, the seal rings will rotate with the shaft 140 and move away from an axis of bonnet 11 compensate eccentric gap between an axis of the shaft 140 and the axis of bonnet shaft hole, finally there are two sealant teeth 143, 143′ between the shaft 140 and bonnet 111, teeth 143 with sealant on the shaft 140 will provide dynamic liquid seals with preinstalled sealant with the O ring, teeth 143′with sealant on the bonnet 111 will provide liquid seals with external sealants from port 118 with the O ring 149a.

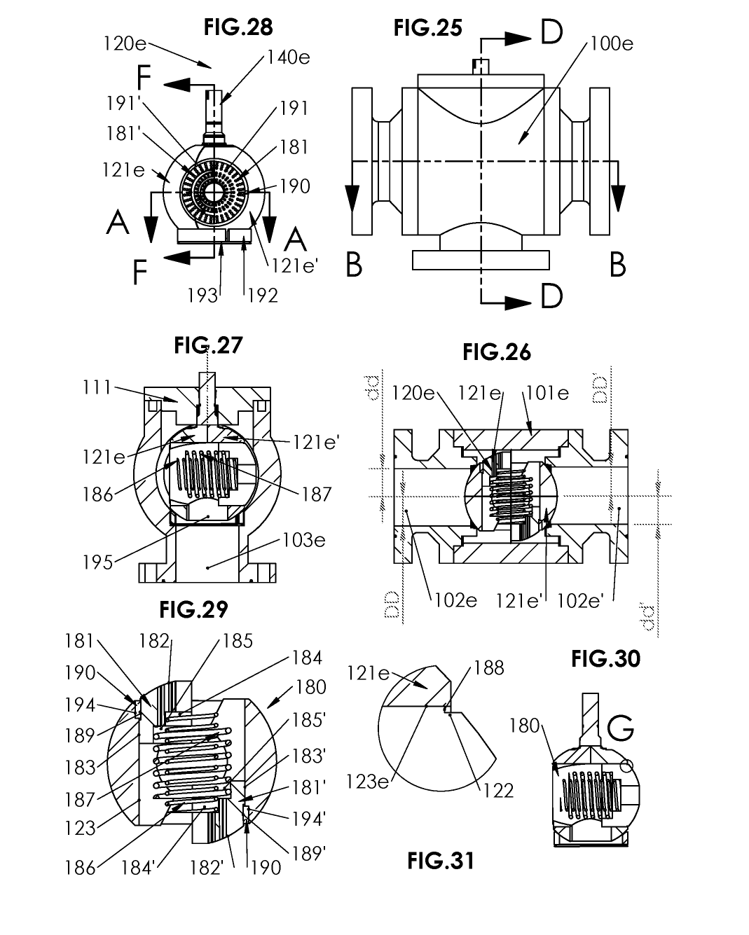

Referring FIGS. 25-31, 34, the relief system 30 comprises a rotary valve 100e, the rotary valve 100e has a body assembly 101e having a left inlet port 102e with an offset line from the X axis defined by DD>dd and a right inlet port 102e′ with an offset line from the X axis defined by DD>dd and a release bore 103e, a closure member assembly 120e, a bottom retaining ring 192 with a disc spring 193 and trim assembly 180 and an outlet port 195, the shaft 140 is coupled with a twin scotch yoke actuator 91c, so it is a torques base relief system not force base relief system (most relief valves), a right side cylinder assembly 239′ is biased by compression air, a left side cylinder assembly 239 is biased by a spring, thus DD area is larger than dd area on the left side, under left inlet port fluid pressures, the closures member assembly trend to rotate anticlockwise to open on the left t side, while thus DD′ area is larger than dd′ area on the right side, the closures member assembly 120 trend to rotate anticlockwise to open on the right side under the right inlet port fluid pressures, when the pressures in inlet ports 102e, 102e′ reach over a set static pressure against the pre-loaded spring 240 and the gas pressure in the twin actuator, the closures member assembly 120 trend to rotate anticlockwise to open and release fluids into the release port, as the twin scotch yoke actuator 91c rotates to the center, the distance from center of the shaft is reduced, the torque=forces×distance, even force based on the spring or gas compression increase, overall a set dynamic pressure would stays the same or closed to the set static pressure, since the offset is by design, so no matter how big the valve, the twin scotch yoke actuator 91c can be much smaller unlike the conventional release valve.

The closures member assembly 120e has a trim 180 having a release bore 195, a left closure 121e having a front step 122, a right closure 121e′ having a front step 122 and springs 187, 186, each of the closures 121e, 121e′ respectively has cylindrical slots 194,194′ and front stops 122, 122′, the trim 180 has left 181 trim and right trim 181′, each of the trims 181,181′ has multiple 191 through holes from small sizes on outward edges to large sizes to center back bores 184 and 185 and a cylindrical slot 189, a front step 188 against the step 122, the trim 181′ has multiple 191′ through holes from small on outward edges to large holes to center, back bores 184′ and 185′ and a cylindrical slot 189′, the trim 180 is inserted into bores 183, 183′, the pins 190,19′ are respectively inserted and secured with closures 121e′ 121e between slots 194 and 189, between slots 194′ and 189′ to guide the trims 181,181′, the trims 181,181′ are biased by springs 186 in step bores 184,184′ and spring 187 in back bores 185,185′ for supporting the trim 180, conditioning fluids between left closure 121e, right closure 121e′ at small opening and spring 187 and spring 186 at middle opening and between spring 186 and middle holes at full opening, as the closures 120e has a small opening due to small over pressure, the pressurized fluid has more resistance on the small holes and push the trims 181, 181′ to the center and push the springs 187,186, the springs 187,186 are compressed with less gaps between each runs, as results the springs 187,186 greatly reduce cavitation by stepping pressure drop through each run and small hole on trim 180 edge, as the closures 120e has a large flow capacity due to a large opening at the center of the trims 180, the pressurized fluid has less resistance on the all holes and push the trims 181, 181′ to the center much with large openings, so the springs 187,186 have lager gaps between each runs and have larger fluid through the trim to reduce release time, it overcome the most conventional release valve dilemma; flow capacity vs anti-cavitation and erosions function.

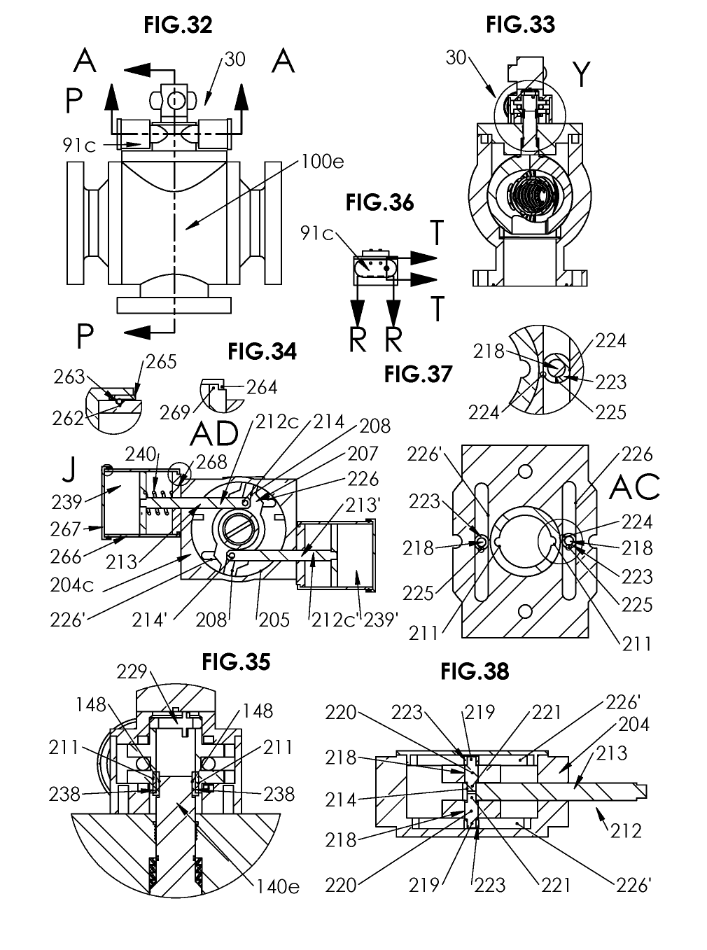

Referring FIGS. 32-38, twin scotch york actuator 91c has two left and right cylinder assemblies 239, 239′ and a housing assembly 204c with a bore 205 and four guide slots 226, 226′, a rotor 207, rotor 207 has two converting slots 208, 208′ is movably disposed in bore 205c, actuator 91c has left and right linear movement assemblies 212c, 212c′, right linear movement assemblies 212c has a rod 213 having a hole 214, two drive pins 218 respectively inserted in the hole 214 and two bushings 223 are respectively disposed in the slots 208,208′ for converting linear movements to rotary movements, the bushing 223 has two flat surfaces 224 engaged with slot 226 for supporting more loads than that of regular cylindrical bushing and reducing wearing and contact stress, the bushing 223 also have a slot 225 to create a spring function and compensate wearing between the flat surfaces 224 and slot 226, the rotor 207 has two pins slots 211 and respectively engaged with two pins 238 for transferring movement between rotor 203 and shaft 140e without backlash, the two pins 218 with bushing 223 not only tolerate more misalignments, but also have much strong middle section in comparison with a single drive pin under high cycle operations, finally cylinder assemblies 239 has a rod-less joint between cylinder 266 with a back step 264 and back plate 268 with stop rings 269 engaged with back step 264 for preventing the cylinder 266 moving out under pressure, while front plate 267 is secured with cylinder 266 by spring ring 263 disposed on a groove 262 of cylinder 266 under pressing of setscrew 265.

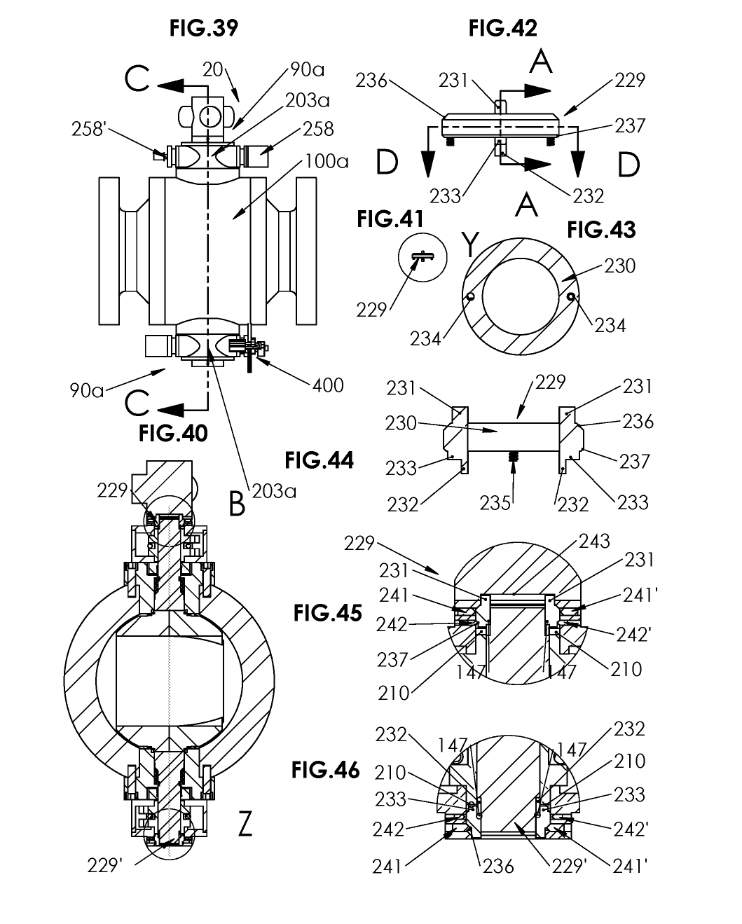

Referring FIGS. 39-46, the isolate system 20 has the isolate valve 100a and the two actuators 90a, 90b, the actuators 90a. 90b have respectively actuator adapters 203a, actuator adapter 203a has a coupling assembly 229 for engagement and disengagement between two left and right drivers 258,258′ and the actuator 90a, the coupling assembly 229 has a coupling 230 and two springs pins 238, the coupling 230 has two top keys 231 for engaging with actuator 90a and two bottom shaft keys 232 respectively engaged with keyways 147 of shaft 140, two lower keys 233 respectively for engaging with two keyways of 210 of a rotor 207 of two left and right drivers 202,201, coupling 230 has two spring hole 234 to receive respectively two springs 235 for keeping coupling 230 at an upper position, coupling 230 has an upper conical surface 236 engaged with conical tipped setscrew/push pin 241, 241′ for pushing down the couple 230, for disengaging with top actuator 200 and engaging with two left and right drivers 258,258′, coupling 230 has lower s conical surface 237 engaged with conical tipped setscrew/push pins 242, 242′ for pushing up the couple 230 for disengaging with two left and right driver 258,258′ and engaging with top actuator 90a, the setscrews/pushing pins 241, 242 can operated by manual or automation control.

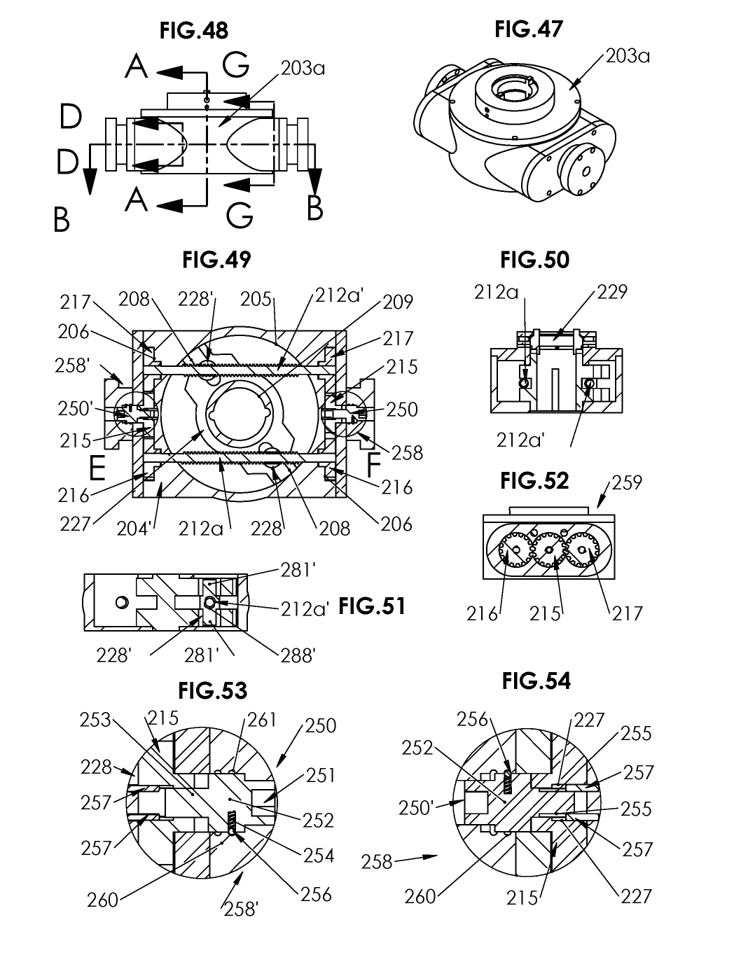

Referring FIGS. 47-54, an universal actuator adapter 203a with a twin scotch yoke driving mechanism has a housing assembly 204′ with a bore 205 and a rotor 227 movably disposed in bore 205, a rotor 227 has a shaft hole 209, a rod groove and two converting slots 208,208′, actuator adapter 203a also has a coupling assembly 229 and left and right drivers 258, 258′, the right driver 258 has a right hand threaded rod 212a, a right hand nut 228 disposed in the slot 208 and a gear train 259, the rod 212a threaded in nut 228 is disposed in housing 204a coupled with a gear train 259, the gear train 259 has a driving gear 215 and two output gears 216,217 respectively coupled with rod 212a and 212a for transferring rotary movements of gear train 259 to rotary movements of rotor assembly 227 through rod 212a and nut 228, the left drivers 258′ has a left hand threaded rod 212a′, a left hand nut 228′ disposed in the slot 208′ and a gear train 259, the rod 212a′ threaded in nut 228′ is disposed in housing 204a coupled with a gear train 259, gear train 259 has a driving gear 215 and two output gears 216,217 respectively coupled with rod 212 a′ and rod 212a for transferring rotary movements of gear train 259 to rotary movements of rotor assembly 227 through rod 212a′ and nut 228, the left and right drive 258. 258′ have respectively have detachable drivers 250, the detachable drivers 250 has a positioner 256, the driver adapter 250 has a position hole 254,a drive shaft 251 and two cylindrical slots 255 for coupling with gear 259 by two pins 257, the driver adapter 250 also has two position grooves 261,261′ for engagement and disengagement positions, the positioner 256 with a ball biased by a spring is disposed in the position hole 254 is engaged with one of grooves 261 and 261′, so the adapter 250 can couple with the left driver 258 for manual operation and the right drive 258′ for electric motor operation, or through couple assembly229 couple with actuator 90a, such a universal adapter not saves lots of installation time from trial or test stage to formal operation, but it has more diversified power choices, finally the driving operation has full balanced feathers at rotor side as well as at gear train side, the actuators coupled with the adapter 203a can be tested with full stroke without effect the valve operation conditions for more reliable full stroke condition of the actuators and partial stoke test can be done with the valves.

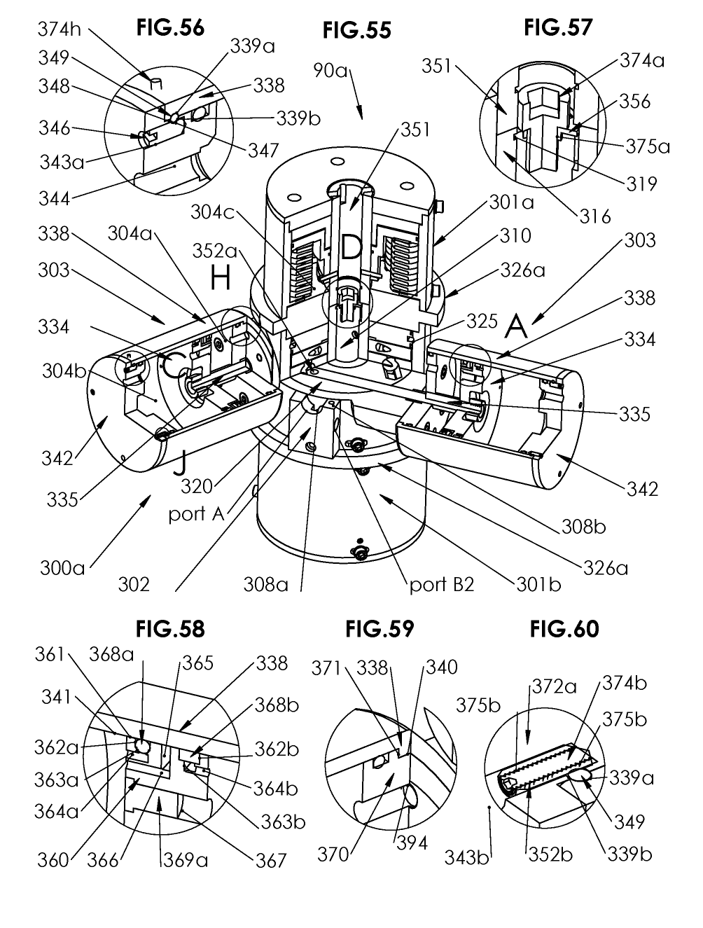

Referring FIGS. 55-60, actuator 90a has a base actuator 300a and a right helical actuator 301a and a left helical actuator 301b, the base actuator 300a has a main rotary drive assembly 310a and three linear drive assemblies 303 and a top interface plate 326a disposed between main rotary drive assembly 310a and the right helical actuator 301a, a shaft 351 of actuator 301a is coupled with a shaft 316 of actuator 300a by a tong and groove joint, there is a groove 319 between shaft 351 and shaft 316 for receiving a split retaining ring 356 for preventing the shafts 316 and 351 from separation under loads, the ring 356 has internal thread 357a to receive a screw 374a for preventing the split ring 358 falling from the groove 319, a bottom interface plate 326a is plated between the left helical actuator 301b and the base actuator 300a, the actuator 300a has a fluid connect pad 302a with port A and ports B1, B2 to connect a 3 ways 2 position directional control valve (not shown).

The linear driver cylinder assembly 303 has a pipe 338 and a front cover assembly 342 and a back cover assembly 370 and a piston assembly 334 and a cavity 304 between piston assembly 334 and back cover 370, the pipe 338 has a back step bore 340 engaged with a step bore 371 of back cover assembly 370 for preventing pipe 338 from pulling out, while the back cover 370 is connected with the body 305a by bolts and has two up and low link ports 394, 394′ respectively connected with two up and low link grooves 325,325′, the pipe 338 has a groove 339a, the front cover assembly 342 has four position holes 343a respectively extended to a groove 339b and a release hole 344 extended to a cavity 304b, two of lock plugs 346 have respectively disposed in the position holes 343a, each of lock plug 346 has an eccentric groove 347, a spring retaining ring assembly 349 with small gaps is disposed in the groove 339b against the eccentric groove 347 of the lock plug 324, as the lock plug 346 is rotated, the eccentric groove 347 pushes the spring retain ring assembly 349 into the groove 339a to preventing the front cover 342 from moving out, a screw 374h is inserted into the enlarged gap of ring assembly 349 for preventing the spring ring assembly 349 from retreating back to the groove 339b, two of retractable spring pins 372a are respectively disposed in the position hole 343b for preventing the spring retaining ring 349 from moving out the groove 339a, the retractable spring pin 372a has a spring pin 352b with an internal thread 375b and a setscrew 374b engaged with internal thread 375b for providing additional strength and retreating the spring pin 352b by threading against a bottom of the position hole 343 to push the spring pin 352b out of the position hole 343b.

The piston assembly 334 has a piston 360, seal rings 368a, 368b, seal plug 369a and a rod assembly 335, the piston 360 has a front shoulder groove 362a for receiving seal ring 368a and creating initial seals and expanding to a link groove 363a and four link ports 364a to cavity 304a for creating additional fluid energized seals from fluid energized pressure from cavity 304a, a back shoulder groove 362b for receiving seal ring 368b and creating initial seals and expanding to a link groove 363b and four link ports 364b to cavity 304b for creating additional fluid energized seals from fluid energized pressure from cavity 304b and a middle sealant/grease groove 365 extending to middle link ports 366 for providing seals and lubricant function and pressurizing the sealant when a pressurized fluid is applied to cavity 304a, the triple seal mechanism not only increase seal ability with solid-liquid-solid under static or dynamic conditions and seal life by four time in compassion with the conventional bearing and seal mechanism, but also reduce the friction between seal rings and pipe by 60% without over compression of seal rings and slide load like conventional scotch yoke actuators piston.

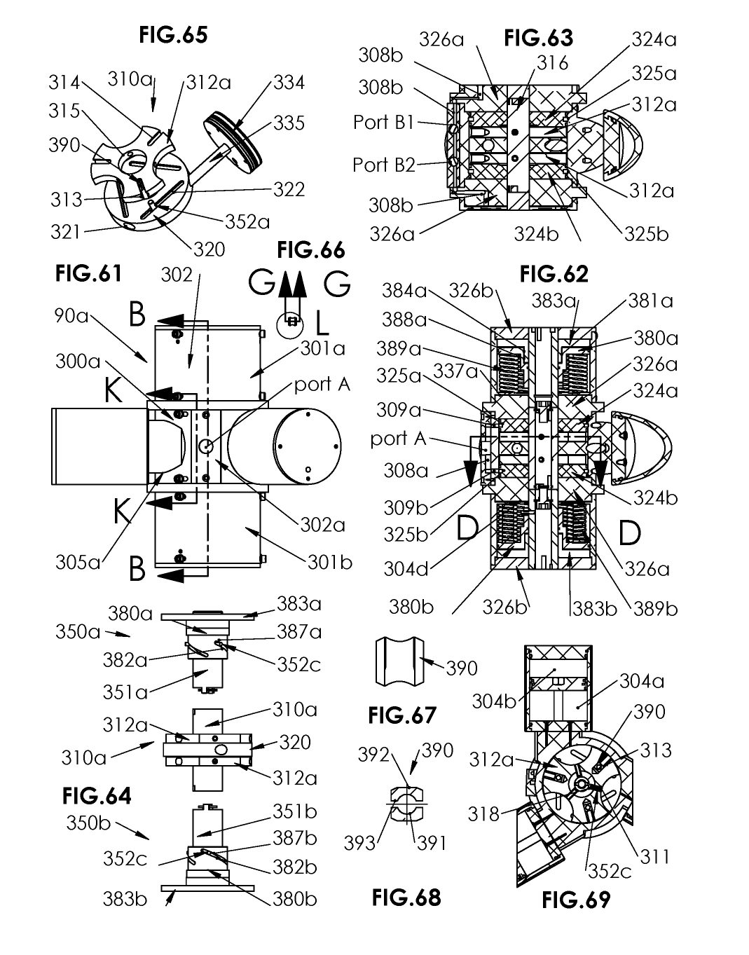

Referring FIGS. 61-69, the base actuator 300a has a body 305a and two seal plates 324a and 324b and a fluid pad 302a with port A extending fluid passage 308a, the body 305a has ports 309a and 309b through passage 308a respectively to connect a link groove 325a of seal plate 324a and a link groove 325a of seal plate 324a extended to cavity 304a, the fluid pad 302a also has ports B1 and B2 connected by a fluid passage 308b respectively extended to actuators 301a and 301b through the upper interface plate 326a and through the lower interface plate 326a.

The base actuator 300a has a rotary flexible driving assembly 310a, the rotary driving assembly 310a has a hollow shaft 316 with top three pin holes 318, three bottom pin holes 318 and two rotors 312a and six spring pins 352c and six position bearings 390 and three drive pins 352a and a guide plate 320 placed between rotors 312a, each of the rotors 312a has a shaft bore 315 to receive shaft 316, three pin holes 311, three spring pins 352c are respectively disposed between holes 311 and holes 318 for transferring loads between the shaft 316 and rotor 312a, each of rotors 312a has three radial,cylindrical, slots 313 respectively receiving three position bearings 390 and expanding to top and bottom three pin slots 314 respectively receiving three drive pins 352a, each of cylindrical position bearing 390 movably disposed in slot 313 has a pinhole 391 to receiving pin 352a and a larger OD surface pressed into slots 313 with a gap 393 with a spring function to compensate any wearing between bearing 390 and slot 313, the guide plate 320 has three rod holes 321 respectively to receive rods 335 and expanding to top and bottom three pin slots 322 to receive three pins 352a, the linear rod 335 has a pin hole to receive pin 352a for converting linear movements to rotary movements of shaft 316 through engagements between drive pin 252a and position bushing 390 in bushing slots 313 and pin slots 322 in guide plate 320, the high integral linear-rotary converting system keep the system flexible, balanced but still has a highly integrity and interconnection without loosed parts, while the conventional scotch yoke actuators with the vertical position bushing with linear contact are easy wearing out with large clearance and lost motions. As a single converting unit, the driving assembly 310a is easily to be assembled or disassembled, the spring pins 352c not only absorb impact forces to protect valve seat and packing during operations, but also would be broken under pre-set load as safety devices to protect the actuator as whole as well valves

The right helical actuator 301a has an interface plate 326b, a shaft assembly 351a with three drive pins 352c, and an offset sleeve 383a with an offset surface 384a, a helical sleeve 380a and three helical slots 382a respectively receiving the drive pins 352c for generating right helical movements and a matched offset surface 381a engaged with the offset surface 384a for creating reaction forces against the helical movements in order to rotate the shaft assembly 351a clockwise and a spring set 389a placed between helical sleeve 380a and interface plate 326b for storing compression energy as a spring return forces.

The left helical actuator 301b has an interface plate 326b, a shaft assembly 351b with three drive pins 352c, and an offset sleeve 383b with an offset surface 384b, a helical sleeve 380b and three helical slots 382b respectively receiving the drive pins 352c for generating left helical movements and a matched offset surface 381b engaged with the offset surface 384b for creating reaction forces against the helical movements in order to rotate the shaft assembly 351b anticlockwise and a spring set 389b placed between helical sleeve 380b and interface plate 326b for storing compression energy as spring return forces.

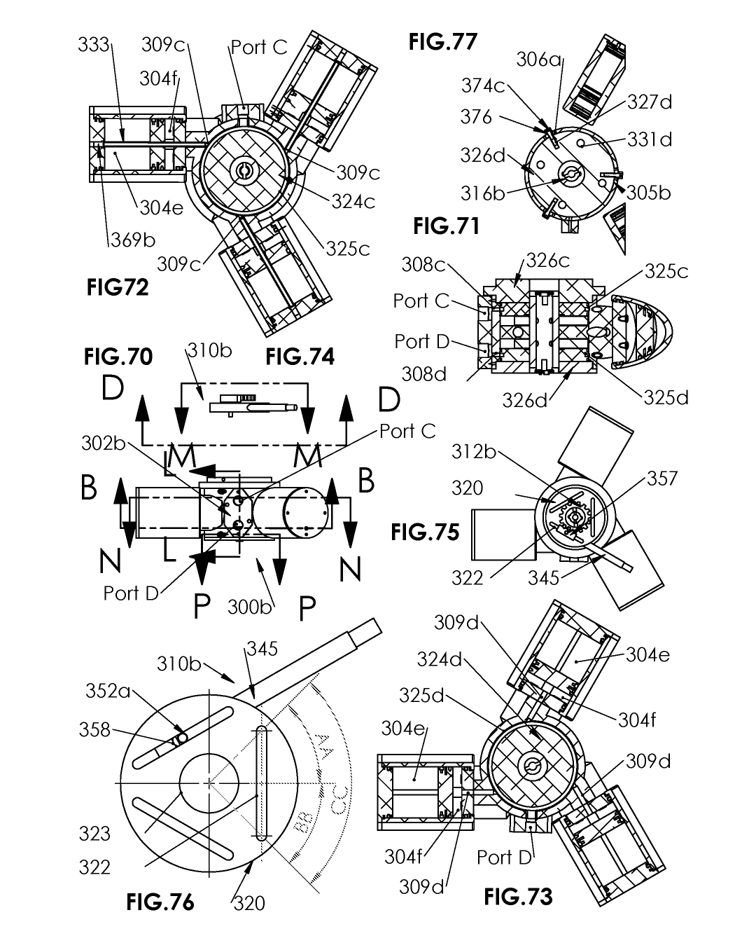

Referring FIGS. 70-77, a base actuator 300b has a fluid pad 302 b with ports C, D, a top interface plate 326c and a bottom interface plate 326d and a body 305b with ports 308c 308d, two seal plates 325c, 325d and a rotary driving assembly 310b, the port C is connected to cavity 304e through body port 308c, a link groove 324c of seal plate 325c, a cover port 309c, tubing 333, while the port D is connected to cavity 304f through body port 309d, a link groove 324d of seal plate 325d, a cover port 309d, the body 305b has a step bore 330a and three position slots 306a, the interface plate 326d has four holes 331d and three side holes 327d and a step boss 329d engaged with the step bore 330b, three screw/washers 374c and 376 are respectively inserted into the three side holes 327d through the position slots 306a for adjusting relative positions between the shaft 316d and interface plate 326d, for 99% applications of the shaft adjustment, the requirements are to adjust the relative positions between the shaft 316d and the interface plate 326d.

The rotary driving assembly 310b has the guide plate 320 and two driving gears 312b and racks 357 placed respectively above and below the guide plate 320 for converting the linear movements of the rods 345 to rotary movements of gears 312b through the racks 357, the rack 357 has a boss pin 358 engaged with a pin slot 322 of the guide plate 320 for preventing rack 357 from rotation.

The guide plate 320 has three rod holes 321 respectively to guide the rods 345 movements and three pin slots 322 to restrict the linear travel of the rod 335 as an absolute rotation position of shaft 316b, rotary angle 90 degree=AA+BB for most rotary valve shafts, if they are sympatric, AA=BB=45 degree, or they can be different with a cam effect, it means one side torque at end of 0 or 90 degree is different from other side at end of 90 degree or 0 degree, let's say AA+BB=30+60=90, CC can be less or larger than 90 degree as conventional scotch yoke cam profiles, but it is much simpler

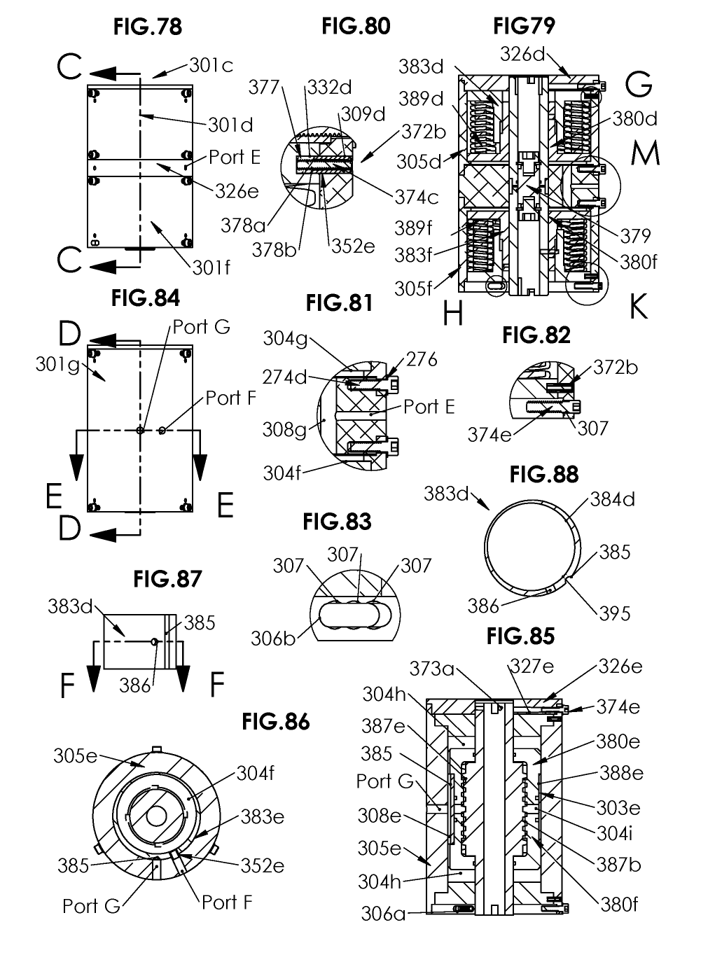

Referring FIGS. 78-88, a helical actuator 301c assembly has a right helical actuator 301d and a left helical actuator 301f and interface plate 326e with a port E as a spring return actuator installed on the base actuators 300a or 300b or as a spring actuator with additional interface plate 326d at a bottom, the helical actuator 301c has an interface plate 326d, a body 305d with six position slots 306a and six position holes 305f connected with the interface plates 326d and 326e, the right helical actuator 301d also has an offset sleeve 383d with three side holes 332d below the interface plate 326d, a right helical sleeve 380d on the top of interface plate 326e, a spring set 389d is placed between the offset sleeve 383d and helical sleeve 380d, the left helical actuator 301f connected with interface plate 326e has a body 305f with six side holes 327f, a body 305f connected with interface plate 326e has four side position slots 306a and two position slots 306b, the left helical actuator 301f also has an offset sleeve 383f, a left helical sleeve 380f, spring set 389f is plated between the offset sleeve 383f and left helical sleeve 380f, a pressurize fluid in port E is connected to cavity 304g through passage 308g to push the right helical sleeve 380d up to rotate the shaft 351d and compress the spring set 398c and to cavity 304f through 308g to push the left helical sleeve 380d down and rotate the shaft 351f and compress the spring set 398f.

The offset sleeve 383d has three side holes 332d respectively to receive three retractable spring pin assembly 372b through body position holes 305f, the pin assembly 372b has a spring pin 352d with a wedge surface 378a, a nut 377 with a mated wedge 378b engaged with the wedge surface 378ea, a screw 374e is inserted into the nut 377 through spring pin 352d for preventing the sleeve 380d from moving under loads, the screw 372e not only increase the spring pin 352d strength, but also can retreat the spring pin 352 by threading in the nut 377 to push the spring pin out either by the wedge engagement between the nut 372 and spring pin 352d or the engagement between nut 377 and a bottom of hole 332d to push the spring pin 352d out, body 305f has two position slots 306b, each of slots 306b has three cyclical slots 307, a screw 374e is inserted in the slots 306b with three fixed positions of slots 307.

A double acting helical actuator 301g has a body 305e with ports G and F can be installed with the base actuator 300a or 300b or used as an interdepend actuator with an interface plate 326g, A helical actuator 301g also has an offset sleeve 383d, a right helical sleeve 380e and a left helical sleeve 380f and two seal plates disposed on both ends of the body 305e and a helical shaft with right helical teeth and left helical teeth, the offset sleeve 383d has an offset ID surface 384d and a hole 386 to connect to304f and port F and a slot 385 concerted cavity 304h and port G with and pressure fuse 396, the right helical sleeve 380f has mated helical teeth 387b engaged with right helical teeth of the shaft for helical engaging movements and has a mated offset surface 388f engaged with surface of 384d for reaction engagements to rotate the shaft, the left helical sleeve 380e has mated helical teeth 387e engaged with right helical teeth of the shaft for helical engaging movements and has a mated offset surface 388e engaged with surface of 384d for reaction engagements to rotate the shaft.

Port G is connected with cavity 304h through passage 308e between slot 385 and body 305e, port F is connected to cavity 304i through lock tubing 352e and hole 386, the interface plate 326e has side through hole 327e to receive screw 374e for securing a position between body 305e and interface plate 326e, the shaft can be fixed with 374e through 327e into 373a hole.

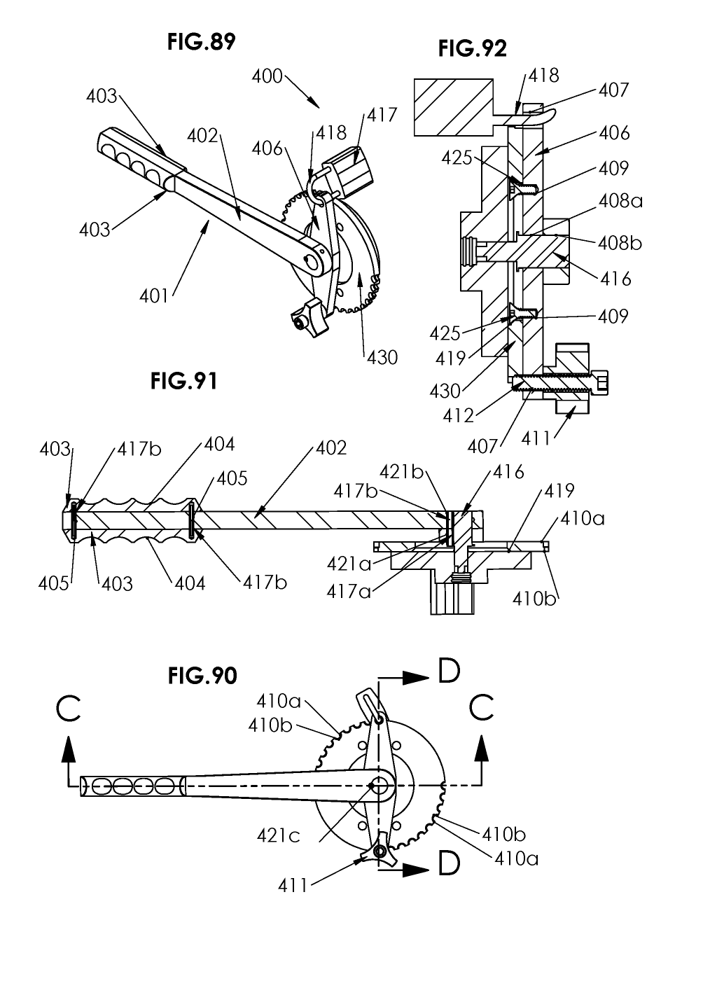

Referring FIGS. 89-92, a detachable handle assembly 400 coupled with right drive adapter 258 of actuator adapter 203a has a handle assembly 401 and a position plate assembly 430, the handle assembly 401 has a base 402 with one shaft bore 408b with a spring pin slot 421c and two grips 403 and two spring pins 417b, each of grips 403 has four figure slots 404 and two bottom holes 405, the spring pins 417b are placed between the grips 403 for securing the grips 403 with base 402, the position plate assembly has a position plate 430 having two conical holes 419 and a shaft bore 408a, a lock bar 406, a locker 418 and a position screw 412 and a nut 411, and two flat screw 425, the lock bar 406 has a shaft bore 408b with a spring pin slot 421a and two thread holes 409 on both ends and two bottom thread holes 409, two screws 425 are respectively threaded into the holes 409 from the bottom of position plate 406 for securing connections between the position plate 430 and the lock bar 406, the position plate 430 has two set of step cylindrical slots 410a, 401b on an opposite direction, since shackle diameter of locker 418 is smaller than that 410b, so the locker 418 is used to lock a position through slots 410, 410b for preventing unauthorized operation, while the position screw 412 is larger than slot 410b and smaller than slot 410a, the position screw 412 is used to locks a position with nut 411 and position plate 430 for preventing vibration or unwanted valve closure member movements, each set of position step slots 410a, 410b covers 0-180 degree or less, so the the handle assembly 401 can be removed after operation without effect of valve closure member position unlike conventional handles act like a locking device.

### CONCLUSIONS

The present invention provides a long sought solution—an inherent high integrity pressure protection system instead of a combination of conventional low integrity pressure protection devices, the solution is (1) the innovative valve operation mechanism, the twin seal rotary valve with Double isolation and bleeding in one body is based on twin seats and twin closures member with at least two offsets, it overcomes inherent non-positive seat sealing of the conventional ball valve either in float and trunnion styles, according to Newton second law Force=acceleration×mass, the design greatly reduce the closures member mass by half and the friction between closure member and seats to zero between 0-90 degrees, moreover the shaft does not support closure member assembly at closed positions unlike the conventional ball valves, it not only reduce the risk of shaft breakdown at high acceleration but also help to speed up closing operation, as a result, the closing time is reduced to less than one second on the average, the life of sealing elements increase by four times, since the closures member is centered without offsets at open positions, so the valve is pigable for all pipeline applications, finally the two stages operations with the rotary movement between 0-90 and linear movement at 90 degree+will great reduce impact force between seats and closure member at 90 degree+stage because two left and right closures move in an opposite direction and balances the torque by two linear reaction forces from left and right seat assembly and secure the positive seal even under high vibration with wedge lock function (2) In relief unit, for the first time, the relief valve is actuated by the scotch yoke mechanism of rotary moment or torsion instead of linear moment or force, so even the compression of spring or gas would increase as the ball is opening due to offsets, the output torque is decreased to middle, so overall set dynamic pressure would stay about the same, the difference between the set static pressure and set dynamic pressure remain less than 5%, the valve has more sensibility to trace the pressure even after opening, the blowdown pressure can be reduced to 3 to 5% and great reduce energy loss of controlled fluid, because the valve torsion mechanism is based on the offset between DD and dd and area of the body port, fluid pressure, while the actuator is based spring or compression gas cylinder still can be designed at smaller size unlike conventional linear relief valve, finally the twin seal valve provide a redundant relief mechanism with two inlet ports in one body and redundant pressure tracing mechanism with spring and compressible gas with no temperatures effect due to the same gas in a contained cylinder (3) both isolating overpressure fluid from normal pressure zone and releasing overpressure fluid into low pressure zone, greatly reducing total shut off time or impact time, risk of water hamper damage or pressure surge in normal pressure zone, rather than the old response time, which is meaningless (4) by nature, the rotary valve has the less volume replacement over other linear valves with the same size bases, in isolate side, the rotary assembly is much faster to close than other conventional linear or ball valve valves due to less fluid resistance with the same moving direction, or secondly a combination of the immediate sensing and releasing and a distant sensing and releasing, for the first time, the relief valve can handle both clear fluid or dirt fluids without passage blocking, sensing valve, (4) redundancy, inherent redundancy include (a) the left and right closures assemblies in the valve (b) the left and right actuations (c) external and internal actuation energies (d) top and bottom actuations (e) immediate sensing and a distinct sensing (f) compression spring and compressible gas sensing.

The present invention discloses other breakthrough achievement—Hybrid wedge seal rings for both seat seal and shaft packing seal, the isolate valve and relief valve bring in great challenge for sealing in fast speed of closing and opening with high impact force, high frequency for relief valve and fire safety applications, so far there is no single seal ring to meet the challenge with soft seal or hard metal seal. Any leak can happens under two conditions, one there are gaps or leak path between two seal surfaces, other is the pressure difference between leak path ends, so no gap or leak path, no leak, even with leak path or gasp, as long as there is no pressure difference, still no leak, so this breakthrough is based the leak principle, soft seal material like rubber or PTFE can fill gaps or leak path between two seal surfaces, but are not strong enough to hold high pressure, while metal seal can hold high pressure, but is not good to fill gaps between two surfaces, in most cases metal to metal seal is required with surface finish less 16 RMS.

The wedge ring seat assembly combine strengths of both metal material and nonmetal materials by filling soft material in the gaps or leak paths and placing metal seal materials in the middle to hold the seals from both upstream and own downstream under pressures unlike the conventional ball and butterfly valves with metal ring on side, moreover the metal wedge ring acts as a spring and push internal ring and out ring radially expand by up to 50% of compression force as well as provide with axial compression seals hold the pressure from both upstream and downstream even with PTFE, while conventional ball valves with PTFE seat with spring cannot stand for high pressure over class 300, the wedge ring seat assembly can be used for rotary valve as well as linear valves like gate valve, one very important for the combined seal ring is the cryogenic application, like LNG terminals, there are fast shutoff valves between LNG plants and LNG vessels, but the most PCTFE are used for cryogenic applications and cannot stand for high impact, fast closing and leak after some cycles, especially for the valves with size 4″ up, while metal seal like Inconel only can hold pressure at low temperatures but cannot stand for high temperature difference between external while wedge seal ring with PTFE as non-metal materials assembly can stand pressure class up to API 20,000 PSI or ANSI class up to 4500 without reinforced materials.

The wedge shaft packing unlike conventional shaft packing is the first stem packing in the world to aim the root of causes for shaft leak and fugitive emission, unlike conventional V packing, graphite yard packing, lip seals and other recent developed packing steals, the wedge shaft packing distinguish static seals from dynamic seals, they are two different seals by natures, according to a recent study related to this invention, the dynamic seal has four major issues related to shaft leak and fugitive emission (1) dynamics enlargement accounts for about 40% of shaft packing failure due to relative movements between the shaft and packing with offsets between the shaft axis and packing axis (2) wearing accounts for about 30% of shaft packing failure due to dynamic frictions between packing and shaft (3) Accelerated chemical corrosion accounts for about 15% of shaft packing failure due to relative movements between the shaft and packing (4) foreign object inclusion accounts for about 10% of shaft packing failure due to relative movements between the shaft and packing, while static seal has no four issues, most valve and packing manufactures do not recognize the root of causes, the internal wedge packing assembly as an active wedge ring is designed to provide dynamic seals between the shaft and the packing with those four issues,while the external wedge ring assembly as a passive wedge is designed to handle static seals between the packing and the stuff box without those four issues, the internal wedge ring assembly is made of high density, anti-wearing materials with like Inconel wires constant filling the gaps or leak paths, the metal support ring is designed to provide anti-dynamics enlargement and hold pressure between each wedge packing assembly and prevent foreign objects and provide accelerated corrosion with special materials like zinc, finally external wedge ring assembly is deigned to generate more backup force with flexible material with scarified metal rings, so the internal and external wedge assemblies resolve most conventional packing problems with much lower cost efficiently and effectively, the metal wedge is designed to provide up to 50% of high radial compression force from axial compression forces, much higher than any passion ratio, since the wedge ring is under buckling, the lager deformation happen away below the yield strength of the material with special material or heat treatment, the wedge metal ring not only fill any gap between the internal ring and external ring but also provide compression force for fugitive emission less than 50 ppm to meet EPA concern decree and API 622, 624, 641 for both rising stem as well as part turn stem valves, while without the wedge spring ring, the conventional graphite seal material can covert the compression force radial force by 17% of compression force as the Poisson rate even with live-loaded devices, while wedge seal ring with PTFE as non-metal materials assembly can stand pressure class up to API 20,000 PSI or ANSI class up to 4500 without reinforced materials, the wedge shaft packing assembly can be used for pump shaft instead of the expensive mechanical seal assembly with high support force with support ring and metal wedge ring and used for ball valve seat seal ring instead of lip seal which has lower radial support capacity, the wedge seat assembly can hold large size 48 and up, the high pressure API 20,000 and up, such a wedge stem seal ring assembly for both rotary and linear valves and for both a vertical or horizontal positions and provide low cost, but reliable, versatile functions and can last up to 25 years or a million cycles without replacement or readjustment,

The sealant teeth between packing pocket and shaft is a novel solution to both static and dynamic seals for extreme applications like less than 10-50 ppm fugitive emission requirement or high temperatures with 1500 F or more, because of no seal wearing, non-replacement equipment is required and the cost is lower and reliable but a simple structure, since teeth seal self is a sealing mechanism, sealant add additional seal protection, teeth seal can be static or dynamic, the sealant can be pre-installed or externally feeding.

The triple seal mechanism in the actuation a piston is a heart of long life piston in this invention, the compression and pressure energized on both front and back seal rings not only provide adequate seal as normal seal ring and reduce the wearing with less compression and less friction, but also have energized seal to compensate seal ring wearing to extend the life under pressure side through the link holes, the middle groove with sealant not only provides seal and pump the sealant under pressure side,but also provide the constant lubricant to reduce the frication between pipe and seal rings and protect the seal surface from corrosion damages.

The universal adapter is another great invention with valve/actuations joint, the versatile adapter has one output and three inputs, three inputs include manual, electrical, hydraulic or pneumatic power supplies in term power source and quartier turn or multiple turn in term of types, for many installations, the actuations for the valves at beginning are manually operated, after test trials, automated control is added for normal operations, so the couple assembly is set for those applications or emergency and used for engaging or disengaging between one top input and two side inputs, two set gears connected with two rods with right and left threads are provided with two unique multiple turn powered inputs, the two drive pin assembly has not only improve pin strength with large middle section, but also increase durability and strength of bushing with two flat surfaces and spring function with a slot to compensate any wearing of bushing flat surfaces, finally the two or more pin joint between the rotor and shaft not only provides stronger joint for both valve shaft and actuator shaft, but also reduce backlash and stress concentration in comparison with key joint and absorb the impact of valve closing and save valve seats and packing and act as a safety device.

Without high integrated actuation system, the High Integrity Pressure Protection System would not be created, those current problems like unbalanced actuation system which is the inherent problem for the most actuators in the market, the actuation systems without protection device from excessive torsion or unbalanced or loosened joints between actuators and valve account for 80% valve seat or packing failures, so far no single valve or actuator manufacture recognize that, the universal actuation system in this invention is a synergic improvement from two prior patents and is to aim to improve the overall performances by modularizing and equipped with both helical actuator and scotch yoke actuator, the driving unit is joined by spring and coiled pins to absorb fast operation impact or excesses torsion and save the valve seats and stem packing seal, first if the torques reach a designed limit, the spring pin between the valve shaft and actuator haft would be broken as a first safety device, if the torques reach a further designed limit, the spring pins between the actuator shaft and actuator rotors would be broken as a second safety device, so the valve and actuator would be saved with the safety redundancy, the pressure supply system is powered by both pneumatic and hydraulic supplies and more efficiently and safely by reusing exhaust gas from helical actuator to lower pressure scotch yoke actuator unlike the conventional gas over oil actuation release the pressure gas to the air, it not only waste the energy and pollute the air, moreover, the system with a scotch yoke actuator has double acting and a helical actuator with a single acting and spring return can actuate the valves by using the exhaust air from scotch yoke actor into helical actuator as a turbocharged unit, as a result, it not only reduce the spring cost and air consumption, but also increase spring return torque with additional turbocharged torque and operation speed,

The separation between relative position adjustment mechanism and conventional absolute position adjustment is other great innovation in this invention, for most operators in the field, a correct closed position is critical for all rotary valve, even 0.5 degree off can cause leak, but 99% of stem position adjustments are about the stem relative position to the joint flanges bolt holes with no need to alter a factor set range 0-90+/−0.5 degree, only 1% of the actuation adjustments is an absolute adjustment between 0-90+/−5 or 10 degree, the relative positions adjustments on the rotatable interface plates is a simple solution to 99% problems, for further position security, anti-loosening washers or semi-permanent adhesive may be added with the bolts after setting a correct position, for 1% problems,the factory set 90+/−5 can be solved at the factory, it along saves 60% time in most rotary actuations installation, moreover the top and bottom interface plates can be interchangeable, so without changing the design or installing the cylinder assembly, the direction of rotations of actuator can changed from clockwise e to anticlockwise, or for any valve connection without body change especially in field repairs, it is a great feature, the seal plate and interface plate can be made as a part.

The trim in the ball in this invention provides a simple and effective way to reduce the cavitation and erosion without reducing the fluid capacity, the trim is constructed with multiple through hole from small size from edge to larger size in the center, since the trim is movable and biased by springs, the flow condition can change any time unlike most fixed trim as the rotation of ball, it also can be used for water damping on dams or river or energy dissipating cone valve and terminal fluid control, the springs in the trim not only help install the trim, but also separate one fluid stream into two or three as the opening is increasing and absorb fluid impact and reduce cavitation and erosion

Finally the actuator with bolt-less and tubing-less actuator not only reduce the cost for anti-corrosion expensive bolts by eliminating bolts external corrosion specially under subsea water service, or offshore platform application, or creeping under hot weather, and stand for high cycle operations like high cycle relief application without retightening bolts and increase reliability, but also reduce tubing leak by accident hit during the operation and transportation and reduce the pollution if the naturel gases are used for actuation power supply, multiple fluid pads is one critical part for fast closing less one second without damaging valve seat and stem packing by operating three or two ports at the beginning and one or two ports at the closed position.

Although the description above contains many specifications, these should not be construed as limiting the scope of the invention but as merely providing illustration of some of the presently preferred embodiments of this invention.

Thus, the scope of the invention should be determined by the appended claims and their legal equivalents, rather than by the examples given.

I claim:

1. A fluid control system comprising:
(a) A piping assembly having an inlet section and an outlet section connected with a pipe and a release section and
(b) A hybrid pressure control assembly has at least one pressure-isolate subsystem and at least one pressure-release control subsystem, said subsystem a valve and an actuation system, said valve has a body assembly, a closure member assembly movably disposed in said body assembly and a pair of left and right seat assemblies disposed respectively between said body assembly and said closure member assembly, said body assembly has a flow bore expanding to a left seat pocket and a right seat pocket and is defined by a X axis and a Y axis and a rotary Z axis and a center COO, said left seat pocket has two offsets SA1, SB1, a left off center SO1, a front bore and a back bore, said right seat pocket has two offsets SA2, SB2, a right off center SO2, a front bore and a back bore, said left seat assembly is disposed in said left seat pocket and said right seat assembly is disposed in said right seat pocket, said closure member defined by said X axis, said Y axis, said rotary Z axis has a left closure having offsets CA1, CB1, a left off center CO1 engaged with said left seat assembly at a closed position, said closure member has a right closure having offsets CA2, CB2, a right off center CO2 engaged with said right seat assembly at a closed position, said left closure and said right closure are engaged by a means of a pair of left and right wedge parting surfaces, an angle between said parting surface and said X axis is larger than 0 degree and smaller than 90 degree, said parting surface is defined by said center axis COO, left offsets centers CO1, SO1, right offsets centers CO2 and SO2, said left seat assembly has a seat body including a groove and a wedge seat assembly disposed in said seat body, said seat body has a back OD against said back bore of said left seat pocket for sealing and a front OD surface against said front bore of said left seat pocket with a press fit, said left seat assembly has at least one screw between said seat body and said seat assembly to secure said wedge seat assembly, said right seat assembly has a seat body including a groove and a wedge seat assembly disposed in said seat body, said seat body has a back OD against said back bore of said right seat pocket for sealing and a front OD surface against said front bore of said right seat pocket with a press fit, said right seat assembly has at least one screw between said seat body and said seat assembly to secure said wedge seat assembly, said closure member assembly has at least one a pair of grooves on both top and bottom of said closure member assembly to respectively receive a pair of retaining rings for securing joints between said left closure and said right closure and a disc spring placed between said body and said closure member assembly, said closure member assembly has at least one pair of left rotary groove and right rotary groove and at least one pair of left drive and right slots on said left and right closure member and at least one shaft, said shaft has two drive pins respectively engaged with said drive slots of said closure members and at least two output equally spanned pin slots and two equally spanned keyways, said valve body assembly has at least one bonnet assembly including a pair of guide pins engaged with said left rotary groove and said right rotary groove of said closure member for guiding and supporting said closure member assembly and for rotating said left closure member and said right closure member to an open position as said left offset CO1, right offset center CO2 respectively overlapped with said center COO along with said parting surfaces and to a closed position as said left offset CO1 overlapped with said offset center SO1, said right offset center CO2 overlapped with said offset center SO2 along with said parting surfaces, said closure member assembly has at least one flow port and a left seal band and right seal band engaged respectively with said left seat assembly and said right seat assembly for proving seals between said valve body assembly and said closure assembly, said seal band is constructed with one of a plurality of methods including an integral part of said closures member and an non-integral part of said closures assembly, said seal band has one of a plurality of structures including a flat surface, a conical surface and a spherical surface, a conical surface with an offset angle, a spherical surface a V shaped cross sectional surface, a C shaped cross sectional surface, said valve body assembly has at least one shaft wedge seal packing assembly and at least one inlet port and one outlet port.

2. The fluid control system of claim 1, wherein said wedge seat assembly has a wedge metal seal ring assembly having at least one wedge ring and an internal non-metal mated seal assembly having at least one ring and an external no-metal mated seal ring assembly having at least one ring, said wedge seat assembly has at least one screw through nonmetal rings assembly against said wedge metal ring assembly for securing integrity of said wedge seat assembly, said wedge seat assembly has one of a plurality of sealing surfaces profiles including (a) a conical surf aces for all said ring assemblies (b) a spherical surface for all said ring assemblies (c) a flat surface for all said ring assemblies (d) a conical surf ace for said metal ring assembly and a spherical surface for all non-metal ring assemblies (d) a conical surf ace for said non-metal ring assemblies and a spherical surface for said metal ring assembly (e) a conical surf ace for said non-metal ring assemblies and a flat surface for said metal ring assembly (f) a spherical surf ace for said non-metal ring assemblies and a flat surface for said metal ring assembly,(g) a conical surf aces with an offset angle for all said ring assemblies said wedge ring is defined by an angle larger than 0 degree and smaller than 90 degree.

3. The fluid control system of claim 1, wherein shaft wedge seal packing assembly disposed between said bonnet and said shaft for seals has one of a plurality of structures including (a) internal non-metal wedge ring assembly/metal wedge ring assembly/external non-metal ring assembly (b) internal non-metal wedge ring assembly/external non-metal ring assembly, said metal wedge ring assembly has at least one wedge metal ring, said an internal non-metal wedge seal assembly has at least one non-metal wedge ring, said external no-metal wedge seal ring assembly has at least one non-metal wedge ring, said wedge seat assembly has at least one metal support ring, said wedge ring is defined by an angle larger than 0 degree and smaller than 90 degree, top and bottom surfaces of said shaft wedge seal packing assembly have one of a plurality of surface profiles including a flat surface, a conical surface, a spherical surface, a V shaped cross sectional surface and a C shaped cross sectional surface, said support ring has a mated surface engaged with said shaft wedge seal packing assembly.

4. The fluid control system of claim 1, wherein said closure member assembly has a trim assembly including a pair of left and right trims and at least one spring, said closure member assembly has a pair left and right cylindrical slots and bumps, a pair of left and right pins respectively disposed in said left slot and said right slot for guiding said trims, said left trim has multiple through holes and at least one back step bore and a left cylindrical slot and a counter step, said right trim has multiple through holes and at least one back step bore and a right cylindrical slot and a counter step, said left trim and said right trim movably disposed in said closure member assembly are guided by means of said left pin and said left pin and restricted by said bumps and said counter steps, said spring is disposed between said back bore of said left rim and said back bore of said right trim for biasing said trims and for conditioning flows and securing said trims.

5. The fluid control system of claim 1, wherein said body assembly has at least one teeth seal assembly between said shaft and said bonnet, said teeth seal assembly has multiple grooves between said shaft and said bonnet and sealants filled in said grooves for sealing and bearing between said shaft and said bonnets, said sealant can be filled by one of a plurality methods including a pre-set amount and an external filling source.

6. The fluid control system of claim 1, wherein said actuation system has an actuator adapter, said adaptor has one output shaft and two input drivers and a coupling assembly, said actuator adapter has a housing assembly with a housing bore and a rotor movably disposed in said housing bore, said rotor has a shaft hole couple with said shaft, a rod groove and left and right converting slots, said actuator adapter also has a left driver and a right driver, said right driver has a right hand threaded rod, a right hand nut disposed in said right slot and a gear train, said right rod threaded in said right nut through said rod groove is disposed in said housing coupled with said gear train, said left driver has a left hand threaded rod, a left hand nut disposed in said left converting slot and a gear train, said left rod threaded in said left nut is disposed in said housing bore coupled with a gear train, each of said gear trains has a driving gear and at least two output gears respectively coupled with said rods for transferring rotary movements of said gear trains to rotary movements of said rotor, said left and right drive respectively have a detachable drive adapter, said detachable drive adapter has at least one positioner, a side shaft adapter and two position grooves for engagement and disengagement positions, said side shaft adapter has a position hole and two cylindrical slots for coupling with said driving gear by two pins, said side shaft adapter also has a position hole, said positioner having a ball biased by a spring is disposed in said position holes engaged with one of said grooves, said actuator adapter has at least two pins coupled with said side shaft of said valve through said pin slots for transferring motions between said valve and said actuation system, said pins have one of a plurality of structures including a solid pin, a spring pin and a coiled pins, said side shaft has two keyways, said couple assembly has a coupling and two springs, said coupling has two top keys for engaging with said actuator of said actuation system and two bottom shaft keys respectively engaged with said keyways of said side shaft, two lower keys respectively for engaging said drivers of said actuator adapter, said coupling has two spring hole to receive respectively said springs for keeping said coupling at an upper position, said coupling has a conical tipped locking pin and an upper conical surface engaged with said conical tipped locking pin for pushing down said couple for disengaging with said actuator and engaging with said two left and right drivers, said coupling has a conical tipped locking pin and a lower conical surface engaged with said conical tipped locking pin for pushing up said couple for disengaging with said two left and right drivers and engaging with said actuator, said lock pin has one of plurality of structures including a setscrew and a pushing pin.

7. The fluid control system of claim 1, wherein said actuation system coupled with said valve has a scotch yoke actuator having at least one piston assembly biased by one of plurality of power sources including springs and pressurized gas, at least one of left and right ports has an offset from said X axis.

8. A valve has a body assembly, a closure member assembly movably disposed in said body assembly and a pair of left and right seat assemblies disposed respectively between said body assembly and said closure member assembly, said body assembly has a flow bore expanding to a left seat pocket and a right seat pocket and is defined by a X axis and a Y axis and a rotary Z axis and a center COO, said left seat pocket has two offsets SA1, SB1, a left off center SO1, a front bore and a back bore, said right seat pocket has two offsets SA2, SB2, a right off center SO2, a front bore and a back bore, said left seat assembly is disposed in said left seat pocket and said right seat assembly is disposed in said right seat pocket, said closure member defined by said X axis, said Y axis, said rotary Z axis has a left closure having offsets CA1, CB1, a left off center CO1 engaged with said left seat assembly at a closed position, said closure member has a right closure having offsets CA2, CB2, a right off center CO2 engaged with said right seat assembly at a closed position, said left closure and said right closure are engaged by a means of a pair of left and right wedge parting surfaces, an angle between said parting surface and said X axis is larger than 0 degree and smaller than 90 degree, said parting surface is defined by said center axis COO, left offsets centers CO1, SO1, right offsets centers CO2 and SO2, said left seat assembly has a seat body including a groove and a wedge seat assembly disposed in said seat body, said seat body has a back OD against said back bore of said left seat pocket for sealing and a front OD surface against said front bore of said left seat pocket with a press fit, said left seat assembly has at least one screw between said seat body and said seat assembly to secure said wedge seat assembly, said right seat assembly has a seat body including a groove and a wedge seat assembly disposed in said seat body, said seat body has a back OD against said back bore of said right seat pocket for sealing and a front OD surface against said front bore of said right seat pocket with a press fit, said right seat assembly has at least one screw between said seat body and said seat assembly to secure said wedge seat assembly, said closure member assembly has at least one a pair of grooves on both top and bottom of said closure member assembly to respectively receive a pair of retaining rings for securing joints between said left closure and said right closure and a disc spring placed between said body and said closure member assembly, said closure member assembly has at least one pair of left rotary groove and right rotary groove and at least one pair of left drive and right slots on said left and right closure member and at least one shaft, said shaft has two drive pins respectively engaged with said drive slots of said closure members and at least two output equally spanned pin slots and two equally spanned keyways, said valve body assembly has at least one bonnet assembly including a pair of guide pins engaged with said left rotary groove and said right rotary groove of said closure member for guiding and supporting said closure member assembly and for rotating said left closure member and said right closure member to an open position as said left offset CO1, right offset center CO2 respectively overlapped with said center COO along with said parting surface and to a closed position as said left offset CO1 overlapped with said offset center SO1, said right offset center CO2 overlapped with said offset center SO2 along with said parting surface, said closure member assembly has at least one flow port and a left seal band and right seal band engaged respectively with said left seat assembly and said right seat assembly for proving seals between said valve body assembly and said closure assembly, said seal band is constructed with one of a plurality of methods including an integral part of said closures member and an non-integral part of said closures assembly, said seal band has one of a plurality of structures including a flat surface, a conical surface and a spherical surface, a conical surface with an offset angle, a spherical surface a V shaped cross sectional surface, a C shaped cross sectional surface, said valve body assembly has at least one shaft wedge seal packing assembly and at least one inlet port and one outlet port.

9. The valve of claim 8, wherein said wedge seat assembly has a wedge metal seal ring assembly having at least one wedge ring and an internal non-metal mated seal assembly having at least one ring and an external no-metal mated seal ring assembly having at least one ring, said wedge seat assembly has at least one screw through nonmetal rings assembly against said wedge metal ring assembly for securing integrity of said wedge seat assembly, said wedge seat assembly has one of a plurality of sealing surfaces profiles including (a) a conical surf aces for all said ring assemblies (b) a spherical surface for all said ring assemblies (c) a flat surface for all said ring assemblies (d) a conical surface for said metal ring assembly and a spherical surface for all non-metal ring assemblies (d) a conical surface for said non-metal ring assemblies and a spherical surface for said metal ring assembly (e) a conical surface for said non-metal ring assemblies and a flat surface for said metal ring assembly (f) a spherical surface for said non-metal ring assemblies and a flat surface for said metal ring assembly, (g) a conical surface with an offset angle for all said ring assemblies, said wedge ring is defined by an angle larger than 0 degree and smaller than 90 degree.

10. The valve of claim 8, wherein shaft wedge seal packing assembly disposed between said bonnet and said shaft for seals has one of a plurality of structures including (a) internal non-metal wedge ring assembly/metal wedge ring assembly/external non-metal ring assembly (b) internal non-metal wedge ring assembly/external non-metal ring assembly, said metal wedge ring assembly has at least one wedge metal ring, said an internal non-metal wedge seal assembly has at least one non-metal wedge ring, said external no-metal wedge seal ring assembly has at least one non-metal wedge ring, said wedge seat assembly has at least one metal support ring, said wedge ring is defined by an angle larger than 0 degree and smaller than 90 degree, top and bottom surfaces of said shaft wedge seal packing assembly have one of a plurality of surface profiles including a flat surface, a conical surface, a spherical surface, a V shaped cross sectional surface and a C shaped cross sectional surface, said support ring has a mated surface engaged with said shaft wedge seal packing assembly.

11. The valve of claim 8, wherein said closure member assembly has a trim assembly including a pair of left and right trims and at least one spring, said closure member assembly has a pair of left and right cylindrical slots and a pair of bumps, a pair of left and right pins respectively disposed in said left slot and said right slot for guiding said trims, said left trim has multiple through holes and at least one back step bore and a left cylindrical slot and a counter step, said right trim has multiple through holes and at least one back step bore and a right cylindrical slot and a counter step, said left trim and said right trim movably disposed in said closure member assembly are guided by means of said left pin and said left pin and restricted by said bumps and said counter steps, said spring is disposed between said back bore of said left rim and said back bore of said right trim for biasing said trims and for conditioning flows and securing said trims.

12. The valve of claim 8, wherein said body assembly has at least one teeth seal assembly between said shaft and said bonnet, said teeth seal assembly has multiple grooves between said shaft and said bonnet and sealants filled in said grooves for sealing and bearing between said shaft and said bonnets, said sealant can be filled by one of a plurality methods including a pre-set amount and an external filling source.

13. The fluid control system of claim 1, wherein said actuation system including:
(13.1) a base actuator has one of plurality of structures including;
(a) a scotch yoke actuator having a housing, at least one fluid pad with ports A, B,a rotary drive assembly and at least one liner drive assembly and a pair of flange assemblies placed on said housing, said actuator has two flow link grooves A, B and at least two relative position adjustment devices between said housing and said flange assemblies, said grooves are connected respectively with said ports A, B and said liner drive assembly, said rotary drive assembly has a converting unit including at least one drive pin, a pair of rotator assemblies and a guide plate placed between said rotator assemblies and a shaft inserted through said rotor assemblies and said guide plate, said shaft is respectively coupled with said rotor assemblies by at least two pins, said rotator assembly has at least one radial, cylindrical slot expanding to top and bottom drive pin slots and at least one bearing, said bearing has a slot and a drive pin hole movably disposed in said radial slot, said guide plate has at least one rod bore expanding to top and bottom drive pin slots, said linear drive assembly has a front cover assembly and a back cover assembly and a pipe placed between said cover assemblies, a piston assembly disposed in said pipe defining a cavity A and a cavity B, said piston assembly has a rod having a drive pin hole, said drive pin is disposed between said drive hole of said rod and said drive hole of said bearing for converting linear movements of said rod to rotary movements of said shaft, said piston has a hole B and a front and back shoulder grooves respectively expanding to button link grooves, a front and a back of said piston through multiple link holes and a grease groove between said shoulder grooves expanding to a side of said piston through grease link holes, said back cover assembly has a tubing and a back cover having a step bore and a port A expanding to said groove A and said cavity A and a port B expanding to said groove B and said cavity B through said tubing and said hole B of said piston, said pipe has a back step engaged with said back step bore of said back cover for preventing said pipe from separation and a front groove expanding to at least one radial hole, said front cover assembly has a lock ring assembly, at least one spring pin-screw assembly, a plug with an eccentric groove and a front cover having a back flow groove to receive said tubing and a lock ring groove to receive said lock ring assembly and at least two bores expanding to said groove to receive said spring pin-screw assemble and said plug, said spring pin-screw assembly has a spring pin having a thread section and a screw threaded into said spring pin for pushing sais lock ring assembly into said groove and by rotating said plug with said eccentric groove against said lock ring assembly in said pipe for prevent said front cover moving out under pressures., each of said relative position adjustment devices has a slot on said housing and a screw assembly into a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches.
(b) a rack and pinion actuator having a housing, at least one fluid pad with ports A, B, a rotary drive assembly and at least one liner drive assembly and a pair of flange assemblies placed on said housing, said actuator has two flow link grooves and at least one relative position adjustment devices between said housing and said flange assembly, said grooves are connected respectively with said ports A,B and said liner drive assembly, said rotary drive assembly has at least one rack and pinion converting unit having one drive pin and one guide pin, two rack assembly and two pinion assemblies and a guide plate placed between said rack and pinion assemblies and a shaft inserted through said pinion assemblies and said guide plate, said shaft is respectively coupled with said pinion assemblies by at least two pins, said guide plate has at least one rod bore expanding to a pair of top and bottom drive pin slots, said linear drive assembly has a front cover assembly and a back cover assembly and a pipe placed between said cover assemblies, a piston assembly disposed in said pipe defining a cavity A and a cavity B, said piston assembly has a rod having a drive pin hole, said drive pin are disposed between said drive holes of said rod and said drive holes of said racks for converting linear movements of said rod to rotary movements of said shaft, said piston has a hole B and a front and back seal shoulder grooves respectively expanding to smaller button link grooves, a front and a back of said piston through multiple link holes and a grease groove between said seal groove expanding to a side of said piston through grease link holes, said back cover assembly has a tubing and a back cover having a step bore and a ports A expanding to said groove A and said cavity A and a port B expanding to said groove B and said cavity B through said tubing and said hole B of said piston, said pipe has a back step engaged with said back step bore of said back cover for preventing said pipe from separation and a front groove expanding to at least one radial hole, said front cover assembly has a lock ring assembly, at least two retractable spring pin assembly and a front cover having a back flow groove to receive said tubing and a lock ring groove to receive said lock ring assembly and at least two bores expanding to said groove to receive said spring pin-screw assemblies, said spring pin-screw assembly has a spring pin with a thread section and a screw threaded into said spring pin for pushing sais lock ring assembly into said groove in said pipe for prevent said front cover moving out under pressures., said relative position adjustment devices has a slot on said housing and a screw assembly in a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches.
(13.2) a helical actuator has one of plurality of structures including;
(a) a single acting spring return helical actuator assembly has a right helical actuator with port B and a left helical actuator with a port B, said right helical actuator has a body assembly, an offset sleeve assembly and a two flanges assemblies placed on said body assembly, a shaft assembly having at least two drive pins and at least one relative position adjusting device between said body and said flange assemblies, said right helical actuator also has a spring assembly and a right helical sleeve having at least two drive slots engaged with said drive pins of said shaft assembly and a mated offset OD engaged with said offset sleeve assembly, said spring assembly has multiple springs and a holding plate having seal rings against said body and coupled with said right helical sleeve assembly defining a spring cavity and a flow cavity connected with said port B, said flange assembly has at least two retractable spring pin assemblies to secure said offset sleeve assembly, said retractable spring pin assembly has a spring pin with a thread section and a screw inserted through said spring pin , said relative position adjustment device has a slot on said housing and a screw assembly into a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches, said left helical actuator has a body assembly, an offset sleeve assembly and two flanges assemblies placed on said body assembly, a shaft assembly having at least two drive pins and at least two relative position adjusting devices between said body and said flange assemblies, said left helical actuator also has a spring assembly and a left helical sleeve having at least two drive slots engaged with said drive pins of said shaft assembly and a mated offset OD engaged with said offset sleeve assembly, said spring assembly has multiple springs and a holding plate having seal rings against said body and coupled with said left helical sleeve assembly defining a spring cavity and a flow cavity connected with said port B, said flange assembly has at two retractable spring pin assemblies to secure said offset sleeve assembly, said retractable spring pin assembly has a spring pin with wedge surface and a nut with a mated wedge surface engaged with said surface of said spring pin and a screw inserted through said spring pin and said nut, each of said relative position adjustment devices has a slot on said housing and a screw assembly into a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches, said helical actuator has a one of plurality confiscations including a combination of said left and right actuators couple with said base actuator and a combination of said left actor and sais base actuator and said right actuator.
(b) A double acting helical actuator has a body assembly with ports G and F and a pair of flange assemblies and a pair of right and left helical sleeve assemblies disposed in said body assembly and a helical shaft having right helical teeth and left helical teeth, a center offset sleeve placed in a middle of said body assembly is defining a cavity G and a cavity F with said shaft, said center offset sleeve has a centric OD, an offset ID surface, a hole G connected to port G and said cavity G and a hole F expanding to an axial slot to said cavity F and a pressure fuse between said holes, said right helical sleeve has mated right helical teeth engaged with said right helical teeth of the shaft for helical engaging movements and a mated offset OD engaged with said offset ID surface of said center offset sleeve for generating reactional engagement to rotary said shaft, said left helical sleeve has mated left helical teeth engaged with said left helical teeth of said shaft for helical engaging movements and a mated offset OD engaged with said offset ID surface of said center offset sleeve for generating reactional engagement to rotary said shaft, said relative position adjustment device has a slot on said housing and a screw assembly into a thread hole of said flange assembly for adjusting a relative position between said flange assemblies and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches.

14. An actuation system has an actuator and an actuator adapter including:
(14.1) a base actuator has one of plurality of structures including;
(a) a scotch yoke actuator having a housing, at least one fluid pad with ports A, B,a rotary drive assembly and at least one liner drive assembly and a pair of flange assemblies placed on said housing, said actuator has two flow link grooves A, B and at least two relative position adjustment devices between said housing and said flange assemblies, said grooves are connected respectively with said ports A,B and said liner drive assembly, said rotary drive assembly has a converting unit including at least one drive pin, a pair of rotator assemblies and a guide plate placed between said rotator assemblies and a shaft inserted through said rotor assemblies and said guide plate, said shaft is respectively coupled with said rotor assemblies by at least two pins, said rotator assembly has at least one radial, cylindrical slot expanding to top and bottom drive pin slots and at least one bearing, said bearing has a slot and a drive pin hole movably disposed in said radial slot, said guide plate has at least one rod bore expanding to top and bottom drive pin slots, said linear drive assembly has a front cover assembly and a back cover assembly and a pipe placed between said cover assemblies, a piston assembly disposed in said pipe defining a cavity A and a cavity B, said piston assembly has a rod having a drive pin hole, said drive pin is disposed between said drive hole of said rod and said drive hole of said bearing for converting linear movements of said rod to rotary movements of said shaft, said piston has a hole B and a front and back shoulder grooves respectively expanding to button link grooves, a front and a back of said piston through multiple link holes and a grease groove between said shoulder grooves expanding to a side of said piston through grease link holes, said back cover assembly has a tubing and a back cover having a step bore and a port A expanding to said groove A and said cavity A and a port B expanding to said groove B and said cavity B through said tubing and said hole B of said piston, said pipe has a back step engaged with said back step bore of said back cover for preventing said pipe from separation and a front groove expanding to at least one radial hole, said front cover assembly has a lock ring assembly, at least one spring pin-screw assembly, a plug with an eccentric groove and a front cover having a back flow groove to receive said tubing and a lock ring groove to receive said lock ring assembly and at least two bores expanding to said groove to receive said spring pin-screw assemble and said plug, said spring pin-screw assembly has a spring pin having a thread section and a screw threaded into said spring pin for pushing sais lock ring assembly into said groove and by rotating said plug with said eccentric groove against said lock ring assembly in said pipe for prevent said front cover moving out under pressures., each of said relative position adjustment devices has a slot on said housing and a screw assembly into a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches.
(b) a rack and pinion actuator having a housing, at least one fluid pad with ports A, B,a rotary drive assembly and at least one liner drive assembly and a pair of flange assemblies placed on said housing, said actuator has two flow link grooves and at least one relative position adjustment devices between said housing and said flange assembly, said grooves are connected respectively with said ports A, B and said liner drive assembly, said rotary drive assembly has at least one rack and pinion converting unit having one drive pin and one guide pin, two rack assembly and two pinion assemblies and a guide plate placed between said rack and pinion assemblies and a shaft inserted through said pinion assemblies and said guide plate, said shaft is respectively coupled with said pinion assemblies by at least two pins, said guide plate has at least one rod bore expanding to a pair of top and bottom drive pin slots, said linear drive assembly has a front cover assembly and a back cover assembly and a pipe placed between said cover assemblies, a piston assembly disposed in said pipe defining a cavity A and a cavity B, said piston assembly has a rod having a drive pin hole, said drive pin are disposed between said drive holes of said rod and said drive holes of said racks for converting linear movements of said rod to rotary movements of said shaft, said piston has a hole B and a front and back seal shoulder grooves respectively expanding to smaller button link grooves, a front and a back of said piston through multiple link holes and a grease groove between said seal groove expanding to a side of said piston through grease link holes, said back cover assembly has a tubing and a back cover having a step bore and a ports A expanding to said groove A and said cavity A and a port B expanding to said groove B and said cavity B through said tubing and said hole B of said piston, said pipe has a back step engaged with said back step bore of said back cover for preventing said pipe from separation and a front groove expanding to at least one radial hole, said front cover assembly has a lock ring assembly, at least two retractable spring pin assembly and a front cover having a back flow groove to receive said tubing and a lock ring groove to receive said lock ring assembly and at least two bores expanding to said groove to receive said spring pin-screw assemblies, said spring pin-screw assembly has a spring pin with a thread section and a screw threaded into said spring pin for pushing sais lock ring assembly into said groove in said pipe for prevent said front cover moving out under pressures., said relative position adjustment devices has a slot on said housing and a screw assembly in a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches.
(14.2) a helical actuator has one of plurality of structures including;
(a) a single acting spring return helical actuator assembly has a right helical actuator with port B and a left helical actuator with a port B, said right helical actuator has a body assembly, an offset sleeve assembly and a two flanges assemblies placed on said body assembly, a shaft assembly having at least two drive pins and at least two relative position adjusting devices between said body and said flange assemblies, said right helical actuator also has a spring assembly and a right helical sleeve having at least two drive slots engaged with said drive pins of said shaft assembly and a mated offset OD engaged with said offset sleeve assembly, said spring assembly has multiple springs and a holding plate having seal rings against said body and coupled with said right helical sleeve assembly defining a spring cavity and a flow cavity connected with said port B, said flange assembly has at least two retractable spring pin assemblies to secure said offset sleeve assembly, said retractable spring pin assembly has a spring pin with a thread section and a screw inserted through said spring pin , said relative position adjustment device has a slot on said housing and a screw assembly into a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches, said left helical actuator has a body assembly, an offset sleeve assembly and two flanges assemblies placed on said body assembly, a shaft assembly having at least two drive pins and at least two relative position adjusting devices between said body and said flange assemblies, said left helical actuator also has a spring assembly and a left helical sleeve having at least two drive slots engaged with said drive pins of said shaft assembly and a mated offset OD engaged with said offset sleeve assembly, said spring assembly has multiple springs and a holding plate having seal rings against said body and coupled with said left helical sleeve assembly defining a spring cavity and a flow cavity connected with said port B, said flange assembly has at two retractable spring pin assemblies to secure said offset sleeve assembly, said retractable spring pin assembly has a spring pin with wedge surface and a nut with a mated wedge surface engaged with said surface of said spring pin and a screw inserted through said spring pin and said nut, each of said relative position adjustment devices has a slot on said housing and a screw assembly into a thread hole of said flange for adjusting a relative position between said flange and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches, said helical actuator has a one of plurality confiscations including a combination of said left and right actuators couple with said base actuator and a combination of said left actor and sais base actuator and said right actuator.
(b) A double acting helical actuator has a body assembly with ports G and F and a pair of flange assemblies and a pair of right and left helical sleeve assemblies disposed in said body assembly and a helical shaft having right helical teeth and left helical teeth, a center offset sleeve placed in a middle of said body assembly is defining a cavity G and a cavity F with said shaft, said center offset sleeve has a centric OD, an offset ID surface, a hole G connected to port G and said cavity G and a hole F expanding to an axial slot to said cavity F and a pressure fuse between said holes, said right helical sleeve has mated right helical teeth engaged with said right helical teeth of the shaft for helical engaging movements and a mated offset OD engaged with said offset ID surface of said center offset sleeve for generating reactional engagement to rotary said shaft, said left helical sleeve has mated left helical teeth engaged with said left helical teeth of said shaft for helical engaging movements and a mated offset OD engaged with said offset ID surface of said center offset sleeve for generating reactional engagement to rotary said shaft, said relative position adjustment device has a slot on said housing and a screw assembly into a thread hole of said flange assembly for adjusting a relative position between said flange assemblies and said shaft, said screw assembly has one of plurality of structures including a screw with a nut, a screw with a washer, a bolt with two nuts and a screw with glues, said slot has one of plurality of structures including a smooth radial slot, a radial slot made out of multiple notches.,

15. The actuation system of claim 14, wherein said actuator adapter has one output shaft and two input drivers and a coupling assembly, said actuator adapter has a housing assembly with a housing bore and a rotor movably disposed in said housing bore, said rotor has a shaft hole couple with said shaft, a rod groove and left and right converting slots, said actuator adapter also has a left driver and a right driver, said right driver has a right hand threaded rod, a right hand nut disposed in said right slot and a gear train, said right rod threaded in said right nut through said rod groove is disposed in said housing coupled with said gear train, said left driver has a left hand threaded rod, a left hand nut disposed in said left converting slot and a gear train, said left rod threaded in said left nut is disposed in said housing bore coupled with a gear train, each of said gear trains has a driving gear and at least two output gears respectively coupled with said rods for transferring rotary movements of said gear trains to rotary movements of said rotor, said left and right drive respectively have a detachable drive adapter, said detachable drive adapter has at least one positioner, a side shaft adapter and two position grooves for engagement and disengagement positions, said side shaft adapter has a position hole and two cylindrical slots for coupling with said driving gear by two pins, said side shaft adapter also has a position hole, said positioner having a ball biased by a spring is disposed in said position holes engaged with one of said grooves, said actuator adapter has at least two pins coupled with said side shaft of said valve through said pin slots for transferring motions between said valve and said actuation system, said pins have one of a plurality of structures including a solid pin, a spring pin and a coiled pins, said side shaft has two keyways, said couple assembly has a coupling and two springs, said coupling has two top keys for engaging with said actuator of said actuation system and two bottom shaft keys respectively engaged with said keyways of said side shaft, two lower keys respectively for engaging said drivers of said actuator adapter, said coupling has two spring hole to receive respectively said springs for keeping said coupling at an upper position, said coupling has a conical tipped locking pin and an upper conical surface engaged with said conical tipped locking pin for pushing down said couple for disengaging with said actuator and engaging with said two left and right drivers, said coupling has a conical tipped locking pin and a lower conical surface engaged with said conical tipped locking pin for pushing up said couple for disengaging with said two left and right drivers and engaging with said actuator, said lock pin has one of plurality of structures including a setscrew and a pushing pin.
